(19) United States
(12) Patent Application Publication
(10) Pub. No.: US 2026/0133278 A1
(43) Pub. Date: May 14, 2026

(54) PRECISE INDOOR POSITIONING AND EVENT DETECTION SYSTEM USING ACOUSTIC SIGNALS, IMU DATA, WIRELESS CLOCK SYNCHRONIZATION, SHARED BEACON CONTROL, MULTI-SPEAKER DEVICES AND TARGETED SIGNAL SEARCHING

(71) Applicant: Takemetuit Inc., Calgary (CA)

(72) Inventors: Douglas Raymond Langen, Calgary (CA); Christopher Erik Henrickson, Chestermere (CA); Alex Messner, Edmonton (CA); Spencer Hayes Nichols, Calgary (CA)

(21) Appl. No.: 19/249,281

(22) Filed: Jun. 25, 2025

Related U.S. Application Data
(63) Continuation of application No. PCT/CA2025/050416, filed on Mar. 25, 2025.
(60) Provisional application No. 63/571,208, filed on Mar. 28, 2024.

(51) Int. Cl. G01S 5/30; G01C 21/16

(52) U.S. Cl. CPC G01S 5/30; G01C 21/165

(57) ABSTRACT

Novel systems and methodologies for precise indoor positioning employs a plurality of synchronized beacons emitting uniquely identifiable acoustic positioning signals in synchronized fashion to one another for receipt by microphone-equipped tracking devices, and beacon controllers emitting wireless synchronization signals receivable by RF receivers of those devices, at least one of which has multiple microphones to enable calculation of both position and orientation. An onboard IMU of each tracking device is used for dead reckoning between acoustic epochs, and for efficiently targeted searching of expected acoustic signals in the captured audio samples. Audio and IMU data captured by the target device is used for event detection purposes, and in the case of the former, to diagnose and remediate or mitigate environmental noise of detriment to the acoustic positioning functionality.

### CROSS REFERENCE TO RELATED APPLICATIONS

This application is a continuation of PCT Application No. PCT/CA2025/050416, filed Mar. 25, 2025, which claims priority benefit of U.S. Provisional Patent Application No. 63/571,208 filed Mar. 28, 2024, each of which is incorporated herein by reference in its entirety.

### FIELD OF THE INVENTION

The present invention relates generally to positioning systems for determining and tracking the location of an object within a monitored space, and more particularly to indoor positioning systems capable of precise positioning within indoor environments.

### BACKGROUND

Indoor positioning solutions have witnessed significant advancements in recent years, driven by the increasing demand for accurate location tracking in various sectors such as manufacturing, logistics, healthcare, and retail. Traditional methods like Wifi, Bluetooth, Ultra Wideband (UWB) based positioning and Simultaneous Localization and Mapping (SLAM) algorithms have played crucial roles but are not without their limitations.

Existing indoor positioning solutions (Bluetooth Low Energy (BLE), WiFi, UWB) cannot deliver precise accuracy in three dimensions (BLE/Wifi are 2-5 m accurate, UWB is 20 cm accurate in 2D), and often struggle to deliver consistent accuracy, especially in complex indoor environments with obstacles, multi-floor structures, and dynamic layouts. This limitation hinders precise positioning required for automation applications and critical operations. Many current indoor positioning solutions struggle with location latency and maintenance of real-time performance, leading to delays and inaccuracies in location data updates. This issue is particularly critical in latency-sensitive applications such as motion measurement and machine automation.

The state of the art for precise indoor positioning at commercial scale only includes LIDAR/Computer-Vision/SLAM based systems, which can achieve sub-centimeter accuracy necessary for automation. However, SLAM sensors have limitations in range and resolution, affecting their ability to capture detailed spatial data over long distances or in challenging environmental conditions. Certain conditions such as fog, dust and low light can impact the performance of LiDAR and camera sensors, reducing their effectiveness. Sensors used with SLAM are typically expensive compared to other sensing technologies, making them less accessible for widespread deployment. Lastly, SLAM sensors typically require a high-speed internet connection for offboard processing, map updates and corrections.

New acoustic-based methods of indoor positioning have emerged that have addressed the accuracy challenges, however, scalability remains a concern, especially when deploying them across large facilities or warehouses and accommodating a high number of simultaneous users/trackers.

The remains need for a compact, cost effective precise indoor positioning system that enables millimeter-level, low latency, 3D positioning that can be deployed across large facilities with support for an unlimited number of simultaneous users and no dependence on a wireless network connection. Such innovation would represent a significant leap forward in indoor location tracking technology, addressing the shortcomings of current solutions and unlocking new possibilities for enhanced accuracy, real-time performance, and scalability in indoor positioning applications.

### SUMMARY OF THE INVENTION

According to a first aspect of the invention, there is provided a target device for use in a positioning system comprising a plurality of beacons of known location emitting respectively identifiable acoustic positioning signals within a space in which said target device is to be tracked, said target device comprising at least two acoustic receivers occupying different points on said target device, and a processor configured to analyze sampled audio from said at least two acoustic receivers to locate therein recorded instances of said respectively identifiable acoustic positioning signals and determine, for successfully located acoustic positioning signals found in said sampled audio, time offsets between transmission of said successfully located acoustic positioning signals by the beacons and reception of said successfully located acoustic positioning signals by the at least two acoustic receivers, for calculation of both an acoustically-derived position and acoustically derived orientation of the target device using at least said time offsets.

In one embodiment, said target device is implemented in a positioning system for enabling determination of a position of a target device within a space, said system comprising:
one or more beacon controllers, each of which has a respective RF transmitter and is configured to repeatedly transmit a wireless synchronization signal therefrom for receipt of said wireless synchronization signal by said target device for clock synchronization purposes enabling calculation of the time offset for determining said acoustically derived position and acoustically derived orientation of the target device; and
for each one of the one or more beacon controllers, at least one beacon that:
   comprises a respective acoustic transmitter;
   is communicatively connected to said one of the one or more beacon controllers; and
   is configured to wirelessly and repeatedly transmit, from said respective acoustic transmitter, and in response to signalled command from said one of the one or more beacon controllers in timed relation to a clock thereof, a respective one of the uniquely identifiable acoustic positioning signals.

According to a second aspect of the invention, there is provided an event and position tracking apparatus for use in a positioning system, said apparatus comprising:
a target device whose position within said space is trackable by the system; and
non-transitory computer readable memory, embodied in said target device or another processor-equipped device communicable therewith, in which there is stored pre-characterized event profiles representative of predefined events detectable within said space using one or more samples or measurements taken by said target device;
wherein at least one local processor of said target device, or at least one other processor embodied in said another processor-equipped device communicable with said target device, is configured to:
compare said pre-characterized event profiles against said one or more samples or measurements taken by said target device to detect occurrences of said predefined events within said space; and
create and store a digital record of any detected occurrence of said predefined events, which digital record includes both a time and location at which said any detected occurrence occurred.

According to a third aspect of the invention, there is provided a position tracking and noise detecting apparatus for use in a positioning system comprising a plurality of beacons emitting respectively identifiable acoustic positioning signals within a space, said apparatus comprising:
a target device comprising at least one acoustic receiver for receiving said respectively identifiable acoustic positioning signals and other audio; and
at least one local processor of said target device that is configured to detect receipt of said respectively identifiable acoustic positioning signals, and determine times of arrival thereof for use in determination of a position of said target device;
wherein said at least one local processor of said target device, or at least one other processor embodied in said another processor-equipped device communicable therewith, is configured to monitor a signal a signal to noise ratio (SNR) measured through said at least one acoustic receiver, and through such monitoring of the SNR, perform at least one of the following actions:
(a) track variation of said SNR relative to a detected position of the target device to assess a whereabouts of a noise source negatively impacting said SNR; and/or
(b) characterize a detected noise negatively impacting said SNR, and based thereon, trigger at least one of the following actions:
(i) attempted removal of said detected noise from audio samples collected and processed to detect receipt of said respectively identifiable acoustic positioning signals; and/or
(ii) modification of the respectively identifiable acoustic positioning signal of at least one of the beacons in a manner intended to improve said SNR.

According to a fourth aspect of the invention, there is provided a position tracking and calibration apparatus for use in a positioning system comprising a plurality of beacons emitting respectively identifiable acoustic positioning signals within a space, said apparatus comprising:
a target device comprising:
   at least one acoustic receiver for receiving at least said respectively identifiable acoustic positioning signals for use in determination of a position of said target device within said space;
   at least one local processor of said target device that is connected to the at least one acoustic receiver and configured to detect receipt of said respectively identifiable acoustic positioning signals, and determine times of arrival thereof for use in said determination of the position of said target device; and
   an inertial measurement unit (IMU) from which inertial measurements are used in supplement to the acoustic positioning signals for tracking of the position of the target device within said space; and
a holder residing at a static location within said space and cooperatively shaped relative to the target device to receive and hold same in a predetermined orientation;
wherein said at least one local processor of said target device, or at least one other processor embodied in another processor-equipped device communicable with said target device, is configured to confirm presence of the target device within said holder, and in response said confirmed presence, trigger calibration of the IMU based on the predetermined orientation imparted to the target device by receipt thereof in said holder.

According to a fifth aspect of the invention, there is provided a positioning system comprising:
a plurality of beacons; and
a target device whose position is to be tracked through cooperative signal interaction with said beacons;
among which a first one of either each of said plurality of beacons or said target device comprises a respective acoustic transmitter operable to transmit a uniquely identifiable acoustic positioning signal, and a second one of either said each of said plurality of beacons or said target device comprises at least on respective audio receiver for receiving said uniquely identifiable acoustic positioning signal;
at least one processor that is connected to the at least one acoustic receiver and configured to detect received instances of said uniquely identifiable acoustic positioning signal, and determine times of arrival thereof for position calculation purposes used to update a tracked position of said target device;
wherein the target device comprises an inertial measurement unit (IMU), and said at least one processor, alone or in combination with another at least one processor, is configured to:
   periodically receive IMU data from the IMU at IMU intervals of higher frequency than acoustic transmission intervals at which the respectively identifiable acoustic positioning signal of each beacon is transmitted thereby;
   use said IMU data to calculate dead reckoned positions of the target device, and update the tracked position of the target device based on said dead reckoned positions;
   using at least (a) one of said dead reckoned positions, and/or (b) a preceding instance of an acoustically derived position of the target device, calculate at least one search space, in which to search sampled audio from the at least one acoustic receiver for the respectively identifiable acoustic positioning signal; and
   search said at least one search space for said respectively identifiable acoustic positioning signal; and
   after successful finding of said respectively identifiable acoustic positioning signal, calculate an updated acoustically-derived position of the target device based at least partly thereon, and updating the tracked position of the target device based at least partly on said updated acoustically-derived position.

According to a sixth aspect of the invention, there is provided a positioning system for enabling determination of a position of a target device within a space, said system comprising:
a first subset of beacon devices configured for regional position tracking of the target device across at least a partial region of said space; and
a second subset of beacon devices configured differently of the first subset of beacon device for subregional position tracking of the target device across one or more smaller subregions of said space.

According to a seventh aspect of the invention, there is provided positioning system for enabling determination of a position of a target device within a space, said system comprising:
one or more beacon controllers, each of which has a respective RF transmitter and is configured to repeatedly transmit a wireless synchronization signal therefrom for receipt of said wireless synchronization signal by said target device for clock synchronization purposes; and
for each one of the one or more beacon controllers, a respective plurality of beacon devices, among which each one of said respective plurality of beacon devices:
   comprises a respective acoustic transmitter or receiver;
   is communicatively connected to said one of the one or more beacon controllers via wired connection; and
   is configured to wirelessly and repeatedly transmit or record, from said respective acoustic transmitter or receiver, and in response to signalled command over said wired connection from said one of the one or more beacon controllers in timed relation to a clock thereof, identifiable acoustic positioning signals for use in determination of time offsets between transmission and receipt of the identifiable acoustic positioning signals for the purpose of deriving at least a position of the target device.

According to an eighth aspect of the invention, there is provided a target device for use in a positioning system comprising a plurality of beacons that operate under control of one or more beacon controllers and synchronously emit respectively identifiable acoustic positioning signals within a space, said target device comprising:
at least one acoustic receiver for receiving at least said respectively identifiable acoustic positioning signals for use in determination of a position of said target device within said space;
an RF receiver for receiving, at least, wireless synchronization signals from said one or more beacon controllers that trigger synchronized transmission of the respectively identifiable positioning signals from said plurality of beacons;
at least one processor that is configured to analyze sampled audio from said at least one acoustic receiver to locate therein recorded instances of said respectively identifiable acoustic positioning signals and determine, for successfully located acoustic positioning signals found in said sampled audio, time offsets between transmission of said successfully located acoustic positioning signals by the beacons and reception of said successfully located acoustic positioning signals by the at least two acoustic receivers; and
at least one audio data buffer continuously populated with audio samples from the at least one acoustic receiver;
   wherein the target device is configured to periodically record from the at least one audio data buffer, in triggered response to at least some of the wireless synchronization signals, a sample window of predetermined sample size, which respective sample window is analyzed for said recorded instances of the respectively identifiable acoustic positioning signals.

### BRIEF DESCRIPTION OF THE DRAWINGS

Preferred embodiments of the invention will now be described in conjunction with the accompanying drawings in which:

FIG. 1 is a schematic illustration of select components of an inventive indoor ultrasonic positioning and event detection system of the present invention (the inventive system, for short), particularly showing a beacon controller and a respective set of beacons operably connected thereto (collectively a beacon group), and a target device whose position is to be tracked using ultrasonic positioning signals from those beacons.

FIG. 2 schematically illustrates a more complete installation of the inventive system, where the beacon controllers of multiple beacon groups installed in respective regions of an overall indoor environment each communicate with a system server over a wired LAN, and overlapping operational zones of the beacon groups cooperatively enable tracking of the target throughout an entirety of the overall indoor environment.

FIG. 3 is a block diagram of the system server, one of the beacon controllers and the target device of the inventive system, illustrating various signal communications therebetween.

FIG. 4 is a block diagram similar to FIG. 3, but with the system server omitted and illustrating a multi-speaker implementation of the target device, characterized by inclusion of multiple acoustic receivers so that the ultrasonic positioning signals detectable thereby can be used to derive not only the position of the target device, but also a full 3D orientation thereof about three orthogonal axis (roll, pitch, yaw).

FIG. 5 is a combined flowchart and signaling scheme illustrating cooperative operation between one of the beacon groups and the target device to achieve clock synchronization therebetween and both acoustically derived and IMU dead reckoned position tracking of the target device.

FIG. 6 is a flowchart illustrating, in greater detail, a clock synchronization procedure executed by the beacon controller in FIG. 5.

FIG. 7 schematically illustrates a timeline, signal scheme and clock drift error in the clock synchronization steps of FIG. 5.

FIG. 8 is a flowchart illustrating, in greater detail, a position calculation process executed by the target device in FIG. 5, which exploits an onboard inertial measurement unit (IMU) thereof both to calculate dead reckoned positions in-between acoustically derived positions, and to derive a position-specific spatial and/or doppler search space for optimal detection of anticipated ultrasonic positioning signals.

FIG. 9 schematically illustrates a timeline, signal scheme and IMU drift error in the position calculation routine of FIG. 8.

FIG. 10 is a block diagram of a multi-channel implementation of the target device particularly well configured for event-detection capability on top of the position-determination capability thereof.

FIG. 11 is a flowchart of a metadata handling routine executable by the target device of FIG. 10 when metadata collection is enabled for event-detection capability.

FIG. 12 is a flowchart of an alternative implementation of the metadata handling routine executable by the target device of FIG. 10.

FIG. 13 is a schematic diagram of a workstation at which a workspace is serviced by both a regional beacon group serving a region of the overall indoor environment in which the workspace resides from a ceiling level of the indoor environment, and a subregional beacon group installed on the workstation closer to ground level for refined position detection specifically within the workspace.

FIG. 14 schematically illustrates use of a target device holder design to hold the target device in a predetermined orientation usable to calibrate the IMU of the target device when it's presence in the target device holder is detected.

FIG. 15 is a flowchart of an event detection process executed by the system server on receipt of event-relevant data from the target device of FIG. 10.

### DETAILED DESCRIPTION

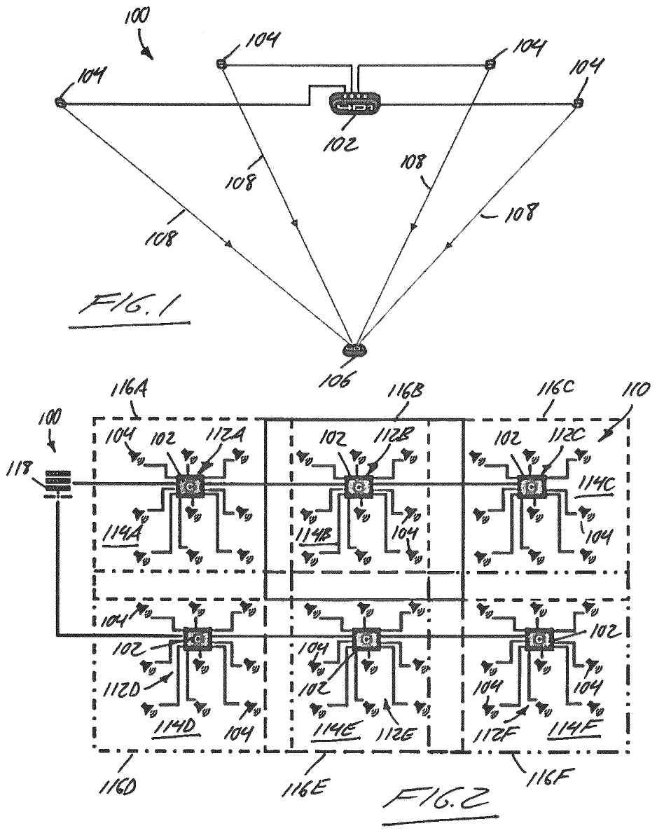

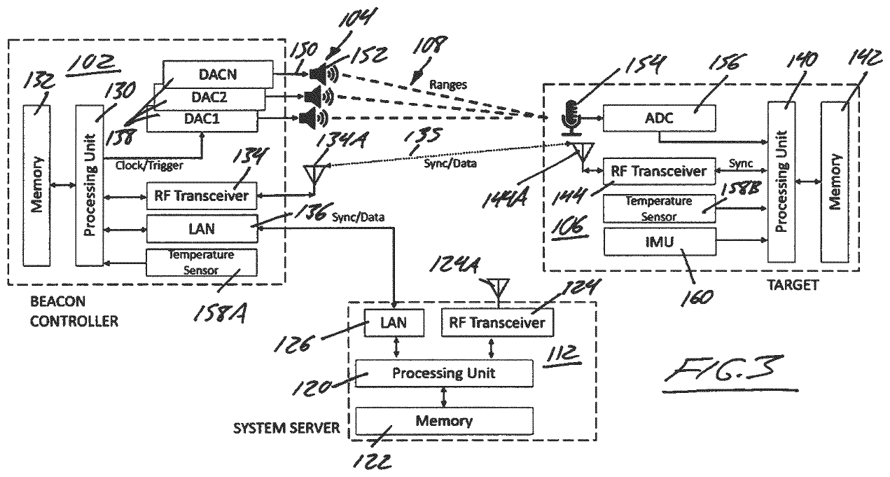

FIG. 1 shows select components of an inventive ultrasonic positioning and event detection system according to one embodiment of the present invention, which for brevity is also referred to herein simply as the inventive system, a more comprehensive illustration of which is given in FIG. 2. The system 100 comprises one or more beacon controllers 102, of which there is only one in the partial system illustration of FIG. 1, but several in the more comprehensive system illustration of FIG. 2, each of which is respectively connected to a set of one or more beacons 104, of which there are multiple beacons in each set of the preferred embodiment shown in the drawings. The beacon controllers 102 and connected beacons 104 are employed for the purpose of enabling determination and tracking of positions of one or more target devices 106 within one or more rooms of an indoor environment of a facility at which the beacon controllers 102 and beacons 104 are installed.

Each beacon controller 102 in the present embodiment relays, over wired connection, a respectively unique acoustic positioning signal to each of the beacons found among the respective beacon set connected to that beacon controller 102, and each beacon 104 among that beacon controller's respective beacon set wirelessly transmits the respectively unique acoustic positioning signal, for receipt of such wirelessly transmitted acoustic positioning signal 108 by each target device 106 when residing within reach of such signal. Thus, the beacons 104 wirelessly communicate with target devices 106 via the acoustic positioning signals 108 for the purpose of determining a range of each target device 106 relative to each of the beacons whose acoustic positioning signals are received. As used herein, the range of an object refers to at least a distance between the object and a reference point, in this case the distance between a target device and one of the beacons 104. In other embodiments, the target device(s) may transmit the unique wireless acoustic signals for receipt thereof by the beacons.

In the present embodiment, the beacons 104 are deployed at known locations within the indoor environment, and the location of each beacon is stored in non-transitory computer readable memory, for example as a coordinate point in a three-dimensional coordinate system of a digital map of the indoor environment. FIG. 2 illustrates a relatively largescale implementation of the inventive system 100 in a relatively large indoor environment 110, such as a warehouse, manufacturing or industrial facility, in which a plurality of the beacon controllers 102 are distributed throughout the indoor environment at different regions thereof, each of which is also occupied by that beacon controller's respective beacon set. In the interest of brevity, an individual beacon controller 102 and the respective set of beacons 102 connected thereto and controlled thereby may be referred to herein as a beacon group.

The multiple beacon groups 112A-112F of the FIG. 2 implementation each occupy a different respective region 114A-114F of an overall two-dimensional footprint of the overall indoor environment 100. Each beacon group acoustically serves a respective zone of the overall different environment, which zones 116A-116F are denoted in the illustration by respective square boxes illustrated in varying line pattern, from which it can be visually appreciated that the zones are of overlapping relationship to one another to ensure that are no dead zones left void of the acoustic positioning signals from the beacon groups. Such overlapping operational zones of multiple beacon groups are particularly implemented in large indoor spaces (e.g. factory floor), whereas more segregated indoor environments divided into separate rooms may not require overlapping zones, at least in smaller rooms respectively servable by a singular beacon group. In this FIG. 2 scenario, the beacon controllers 102 are all connected to a shared system server 118 over a wired local area network (LAN), which LAN is used to synchronize the clock of each beacon controller 102 to the clock of the system server 118, in addition to enabling the sending and receiving data in either direction between the system server 118 and each beacon controller 102. For this LAN-based beacon controller clock synchronization, one embodiment may use IEEE1588—Precision Time Protocol (PTP), which will assign the system server 118 as the “PTP Master Clock”, which is then used as the reference clock signal for the whole network of beacon controllers. In other embodiments, the functionality of the system server may instead be integrated into one of the beacon controllers 102 (i.e. a “master” beacon controller) whose clock is the master, with all the other beacon controllers being synchronized to this master beacon controller master through the LAN.

The target devices 106 are associated with respective movable objects, such as humans, hands or other body parts or clothing thereof, shopping carts, robots, tools, etc. that may move around within the indoor environment, whereby the target device carried by each such movable object is usable to determine and track the position of said movable object within the indoor environment. In a most preferred embodiment, the unique acoustic positioning signal 108 transmitted between a beacon 104 and a target device 106 is an ultrasonic acoustic positioning signal, but in other embodiments may be characterized in any other acoustic range (i.e. subsonic, audible). Suitable signal multiplexing technologies such as frequency-division multiplexing, time-division multiplexing, code-division multiplexing and the like, may be used for communication between the one or more beacons 104 and the one or more target devices 106. As many of these signal multiplexing technologies are known in the art, and as new signal multiplexing technologies are equally applicable to the inventive system disclosed herein, the description that follows may include scenarios that, for simplification purposes, describe a singular beacon 104 communicating with a singular target device 106 for purposes of demonstrating operating principles of the present invention, which principles likewise apply to the similar communications between any of the beacons 104 and any one of the target devices 106.

FIG. 3 shows block diagrams of the system server 118, one of the beacon controllers 102 and one of the target devices 106, and illustrates signal communications between these three components. The system server 118 comprises one more processors 120 (server processor, for short), non-transitory computer readable memory 122 (server memory, for short) operably coupled to the server processor 120, a radio frequency (RF) transceiver 124 (server transceiver, for short) operably coupled to both the server processor 120 and an RF antenna 124A, and a LAN connection 126 operably coupled to the server processor 120. Similarly, each beacon controller 102 comprises one more processors 130 (controller processor, for short), non-transitory computer readable memory 132 (controller memory, for short) operably coupled to the controller processor 130, an RF transceiver 134 (e.g. controller transceiver, for short) operably coupled to both the controller processor 130 and an RF antenna 134A, and a LAN connection 136 operably coupled to the controller processor 130 to enable communication with the server processor 120 via the server's LAN connection 126. Similarly, each target device 106 comprises one more processors 140 (target processor, for short), non-transitory computer readable memory 142 (target memory, for short) operably coupled to the target processor 140, and an RF transceiver 144 (controller transceiver, for short) operably coupled to both the target processor 140 and an RF antenna 144A.

The beacon controller 102 further comprises, for each of a predetermined quantity of beacons 104 selectively connectable thereto, a respective digital to analog converter (DAC) 138 whose output denotes a respective audio channel for relaying a respective uniquely identifiable acoustic positioning signal to the respective beacon 104 via a wired audio connection 150 to a respective acoustic transmitter 152 (e.g. speaker) of that beacon 104, which is responsible for wireless emission of the uniquely identifiable acoustic positioning signal 108. The wirelessly emitted acoustic positioning signal 108 may be a spread spectrum/wide band signal (20-40 kHz, for instance), and the acoustic transmitter 152 (speaker) is of suitable type to support the frequency range of the selected type of acoustic signal, in this case being a wide band, not a narrowband element. In contrast to the beacon's inclusion of an acoustic transmitter, the target device 106 further comprises at least one acoustic receiver (e.g. microphone) 154, which feeds into an analog to digital converter (ADC) 156 whose output is connected to the target processor 140 so that analog output from the acoustic receiver 154 is converted to a digital signal usable by the target processor 140 for processing of sampled audio from the acoustic receiver 154, at minimum for the purpose of detecting of the uniquely identifiable acoustic positioning signals 108 and deriving and recording times of arrival (TOAs) thereof, for use in measuring the range of the target device 106 from the beacons 104 that emitted the detected wireless acoustic positioning signals 108, so that a position of the target device 106 can be derived from such data, as is known in the art. In some embodiments, either one or both the beacon controllers 102 and the target devices 106 may include a temperature sensor 158A, 158B connected the respective processor 130, 140, for use of measured air temperature to account for temperature influence on the travel speed of the acoustic positioning signals, though such temperature influence may be considered insignificant, and the temperature sensors thus optionally omitted. Each target device 106 of the present embodiment further includes an inertial measurement unit (IMU) 160 operably connected to the target processor 140 to provide IMU measurement data thereto, for advantageous and novel uses thereof, which are detailed herein further below. As contemplated above, other embodiments may employ the reverse directionality of acoustic positioning signals, with the target devices 106 emitting such signals and the beacons receiving such signals, in which the case the distribution of acoustic transmitters 152 and acoustic receivers 154 and their respective converters 138, 156 between the beacons 104 and target devices 106 is reversed from that which is illustrated, and the processing of sampled audio to find received instances of those signals would be accordingly be done by the controller processors 130, rather than the target processors 140 in the illustrated instance detailed below.

The RF transceivers 134, 144 and associate antennae 134A, 144A enable high speed RF signal communication between the beacon controller 102 and the tracking device 106. In the present embodiment, the beacon controller 102 uses its wired LAN connection 136 for both time synchronization with the system server 118, and other data communication purposes. Once the beacon controller 102 is synchronized to the system server 118, the beacon controller 102, via the controller transceiver 134, periodically transmits wireless synchronization signals 135 receivable by the target transceiver 144 of each target device 106 in order to synchronize the clock of the target device 106 to the beacon controllers 102 and the system server 118. A variety of hardware and protocol options can be used to achieve wireless clock synchronization between the target devices 106 and the beacon controllers 102, ideally aiming to minimize the clock error as much as possible. In a particularly preferable embodiment, the RF transceiver may be a wireless radio with hardware acceleration (like the Nordic nRF52 MCU) to achieve sub-microsecond clock pulse synchronization at the target devices 106. In one embodiment, the RF transceiver on the beacon controller 102 is assigned as the clock master of the wireless synchronization, which sends radio packets with its time to the target devices (slaves), which receive the radio packets and time stamp and adjust their clocks accordingly. In alternate embodiments, the wireless synchronization signal lacks a time stamp, and instead is only used to relate the slave clock time to a transmission start time t₀ of the synchronously transmitted unique acoustic positioning signals of the beacons 104, which would be enough to establish a relative synchronization of the target device(s) 106. What matters most is the ability to derive the time difference between when each unique acoustic positioning signal is broadcast and received, and relative synchronization may be sufficient for such need.

The same RF communicability between the beacon controllers 102 and the target devices 106 can also be used for other communication purposes, such as sending and receiving commands and data and from target devices 106. Alternatively, the wireless radio used for wireless synchronization may be separate from the wireless radio used for communications (i.e. for example, with nRF for wireless synchronization and WiFi used for communications). In some embodiments, instead of clock synchronization of the beacon controller 102 to the system server 118 through the LAN connections 126, 136, such synchronization may also be performed wirelessly via RF communication between server transceiver 124 and controller transceiver 134, which RF communication may optionally also be used for other communication purposes, such as sending and receiving commands and data to and from each other, just as such RF connection may presently be used in the illustrated embodiment with wired server-controller synchronization.

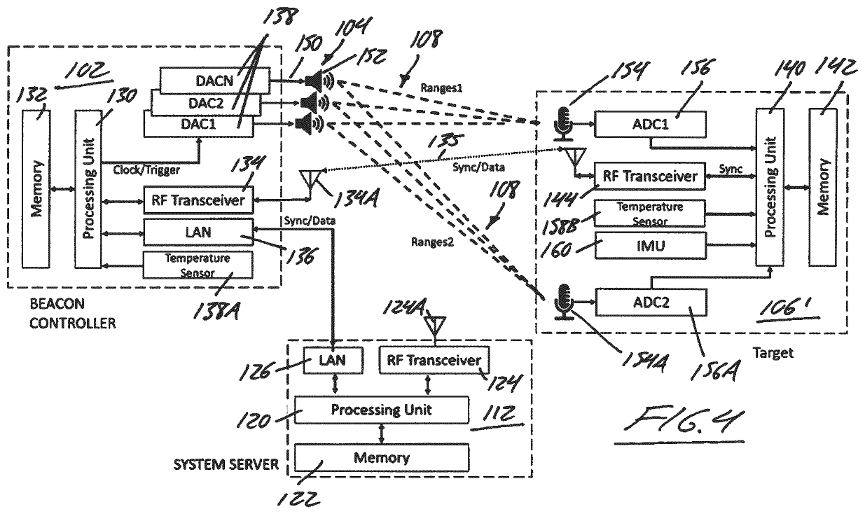

Turning from FIG. 3 to FIG. 4, the latter illustration shows a variant of the target device 106′ that features all the same componentry as the target device 106 of FIG. 3, but also includes a second acoustic receiver (microphone) 154A and an associated second analog to digital converter 156A whose output is connected to the target processor 140. The target processor 140 in this variant of the target device 106′, via synchronously detected receipt of the same wireless acoustic positioning signals 108 at both acoustic receivers 154, 154A, which reside at discretely separate points on the target device 106, is able to calculate respective point-specific positions of the two acoustic receivers 154, 154A at the same point in time, from which, knowing the relative positions of the two acoustic receivers 154, 154A on the target device 106, can be used to calculate an orientation of the target device 106′ about two axes, which orientation can then be used by the processor to recalibrate the IMU, which as used herein means to update the state of the IMU in a drift-corrective fashion toward a truer measure of the target device's actual inertial state, and this case to particularly update the IMU attitude using the acoustically derived orientation as a best-available representation of the true orientation of the target device that is not subject to IMU drift. In yet a further variant, a third acoustic receiver and associated analog to digital converter can be added at another discretely located point on the target device 106′, enabling calculation of a third point-specific synchronous position for the target device for that instant in time, enabling derivation of the orientation of the target device 106′ about three orthogonal axes (pitch, roll and yaw) from the acoustic positioning signals.

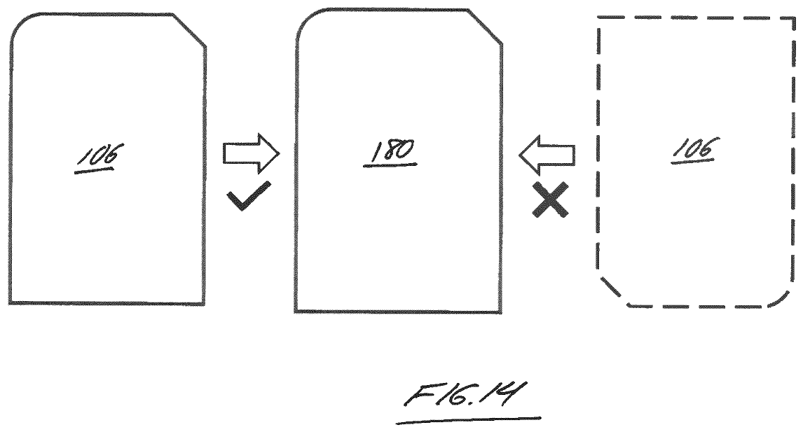

Referring back to the FIG. 3 example of the target device 106 with only a singular acoustic receiver 154, calibration (drift-corrective state update) of the IMU may be performed by the target processor 142 using an alternate means of confirming an orientation of the target device 106, for example through confirmed placement of the target device into a target device holder 180, for example a jig or holster, that is schematically shown in FIG. 13. The target device holder 180 is suitably shaped to accept and hold the target device only in a predetermined calibrating orientation thereof, whereby confirmed receipt of the target device 106 in such held state by the target device holder 180 denotes occupation of that predetermined calibration orientation by the target device, which confirmed receipt is therefore used to trigger recalibration of the IMU 160 of the target device using the known pitch, roll and yaw angles of the target device in said predetermined orientation. In one preferred implementation, a location of the target device holder is stored in the target memory 142, and a calculated position of the target device 106, such as that derived from the acoustic positioning signals 108 (an acoustically derived position), is compared against that stored location of the target device holder, and in the instance of a found match (or near match within a prescribed tolerance) between the calculated position of the target device 106 and the stored location of the target device holder by the target processor 140, the target processor 140 triggers calibration (drift-corrective state update) of the IMU 160. Alternatively, a presence detection sensor (e.g. a switch engaged by properly seated receipt of the target device 106 by the target device holder 180) installed at the target device holder 180 could be used to trigger emission of an RF signal to the target transceiver 144 to signify detected presence of the target device 106 in the target device holder 180, and thus trigger orientation calibration of the IMU 160.

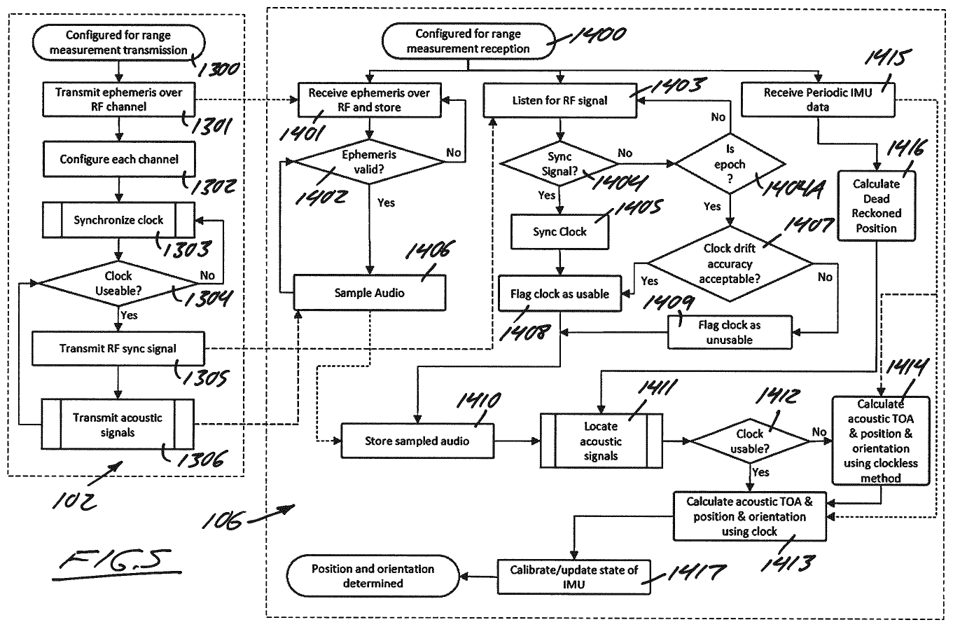

FIG. 5 is a flowchart showing executional steps of a system configuration, clock synchronization and position detection (or range finding) routine cooperatively executed by the processors 130, 140 of the beacon controller 102 and the target device 106, of which the steps executed by beacon processor 130 are numbered as 13NN and the step executed by the target processor 140 are numbered 14NN. First step 1300 is an initiation step that may denote receipt of some sort of starting instruction that the beacon controller 102 has been configured and is ready to be put into use for position detection (range finding) purposes after setup of the beacon controller(s) 102 and beacons 104 in the space in which the position of the of target device 106 is to be tracked. Such starting instruction may be received in the form of one or more commands or successful loading of a configuration file causing storage of system configuration data locally on the beacon controller 102, or a manual input, for example, pressing a button on the beacon controller 102 or in a graphical user interface of the system server 118. Configuration commands or files may be generated from a computer program or service, which automatically configures characteristics of the acoustic positioning signals as needed, or periodically at predefined time intervals, for example using particular predefined acoustic positioning signal sets. The computer program or service may be a program or service running on the system server 118, on the beacon controller 102, on the target device 106, or may be a program or service running in an external device in communication with the beacon controller 102 or the target device 106.

Once configuration has been completed and confirmed, the beacon controller broadcasts ephemeris data to the target devices 106 at step 1301, which ephemeris data contains the known locations and the unique signal definition of each beacon 104 installed in the indoor environment 110, optionally along with other parameters associated with the positioning system (like temperature data, for example), which ephemeris data received by the target device 106 is stored in the target memory 142 at corresponding step 1401. Each channel of the beacon controller 102 is then configured at step 1302 for acoustic signal transmission, which may include the specific unique signal to use for each channel, the broadcast period and other parameters. The specific acoustic signal to use for each channel may be stored locally on the beacon controller 102 in the memory 132 thereof, or downloaded or uploaded from an external source, such as the system server 118. At step 1303, the beacon controller typically receives a synchronization signal from the system server 118 over the LAN connection 136, with which the beacon controller 102 synchronizes its clock to that of the system server 118. A more detailed and robust implementation of this clock synchronization process is described below with reference to FIG. 6, from which it will be appreciated that this beacon controller synchronization may be implemented identically or similarly to the clock synchronization process executed by the target processor 140 of the target device 106 in the right-hand side of FIG. 5, whose steps are described further below.

After a sufficiently synchronized state of the beacon controller 102 is confirmed successful at step 1304, the beacon controller 102, at step 1305, wirelessly transmits a first of a periodically repeated wireless synchronization signal 135 via RF that, owing to the fully or sufficiently synchronized state of the beacon controller 102 to the system server 118, is fully or effectively synchronized with respect to the system server clock, and is receivable by each target device 106. Concurrently or immediately thereafter, at step 1306, the beacon controller 102 outputs the respectively unique acoustic positioning signal to each of its associated beacons 104, which beacon 104 in turn wirelessly transmits its respective unique acoustic positioning signal receivable by each target device 106. All acoustic positioning signals are output according to the configuration information while being synchronized with the system server clock. In preferred embodiments, the unique acoustic positioning signals 108 are each comprised of a unique frequency component across a wide band and a unique information component, the formulation of which signals is described in Applicant's published US Patent Application US2020/0110146, the entirety of which is incorporated herein by reference, and is illustrated in FIG. 4 thereof.

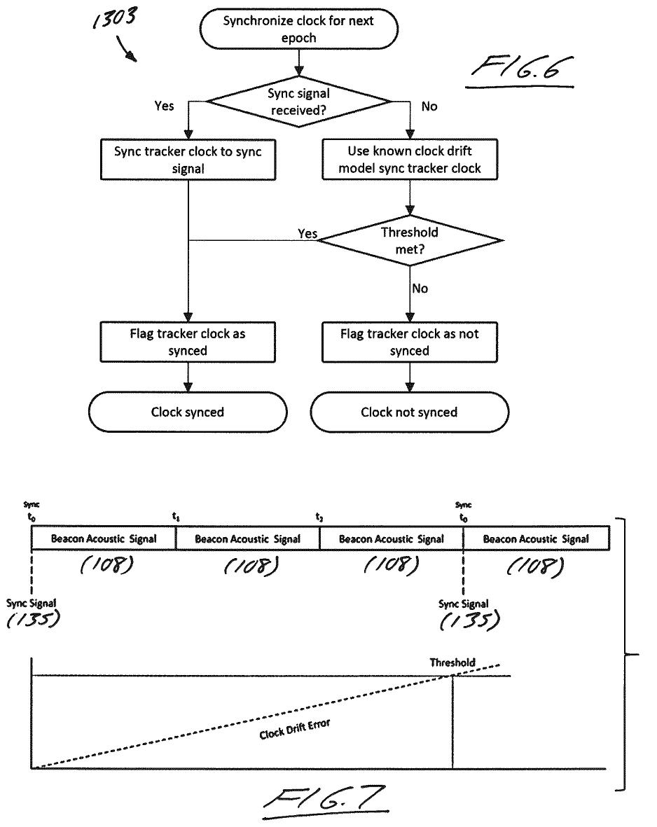

A repeating continuous loop of simultaneously and wirelessly emitted unique acoustic positioning signals 108 may be outputted from the beacons 104 of all beacon groups, of which the differently unique acoustic positioning signals of the different beacons 104 may be differentiated by CDMA (code division multiple access) and FDMA (frequency division multiple access). The length of the continuously emitted unique acoustic positioning signal 108 dictates the ranging frequency in such embodiments. For example, the configuration data may dictate that all continuously emitted unique acoustic positioning signals are 0.05 s long, meaning that a transmission interval from one acoustic positioning signal transmission to the next is likewise 0.05 s long, denoting a 20 Hz ranging frequency. In other embodiments, instead of continuous emission of a unique acoustic positioning signal whose length equates to a full transmission interval, a shorter signal (e.g. chirp) whose length is only a fractional span of the transmission interval may instead be used. In either scenario, the tracking devices 106 sample audio over the full transmission interval to ensure identifiable capture of the transmitted acoustic positioning signal. The wireless synchronization signals may be repeated at a lesser frequency, so that for any two sequential transmissions of the wireless synchronization signal 135 emitted in a given time period, more than two acoustic positioning signals 108 are emitted by each beacon 104. This is visually represented in FIG. 7, where, in the non-limiting context of the illustrated example, for every wireless synchronization signal 135 transmitted, three sequential transmissions of the respectively unique acoustic positioning signal 108 is transmitted from each beacon 104, of which a transmission time to of a first of those three acoustic positioning signals 108 occurs in effective synchronization with the transmission time of the synchronization signal 135. The present invention employes wideband acoustic positioning signals, in contrast narrowband “chirp” signals used elsewhere in the prior art. As described in US2020/0110146, each acoustic positioning signal 108 may be a wideband signal that is encoded at the transmission side (beacon controller 102, in the present embodiment) with an information component and then modulated to an acoustic frequency component for transmission. At the receiver side (target device 106), the received acoustic positioning signal 108 is demodulated and then decoded for further processing. As an alternative to a wideband signal with an encoded information component, a frequency swept wideband acoustic positioning signal may be used.

The preferred embodiment also uses multiple frequency windows for the unique acoustic positioning signals to multiplex two or more positioning subsystems on top of each other within the overall system. In practice, a factory, as one non-limiting example of an indoor environment in which the system 100 may be put to practical use, may need factory-wide positioning coverage for asset tracking and navigation, which is achievable by installation of a first regional subset 104A of the system's total quantity of beacons 104 on the ceiling, rafters or other ceiling-adjacent structure of notable elevation from the floor of the factory, as illustrated in FIG. 13. This may require that target devices 106 need to be oriented with their acoustic receivers pointing upward for successful ranging of the target devices 106 by the ceiling-mounted regional beacons 104A responsible for covering relatively large regions of the overall indoor space throughout which position tracking is enabled by the system.

Concurrently, the application may also require a way to measure complex motion to validate tasks (at a workstation 200 for instance) performed within one or more relatively small subregions of the overall indoor environment. In this case a second subregional subset 104B of the system's total quantity of beacons 104 would be mounted more closely in or around the workstation 200, for example on a framework of the workstation, walls of the workstation, nearby room or building walls, on a work surface of the workstation, etc. In the FIG. 13 example, a first regional subset of beacons 104A, and an associated regional beacon controller 102A connected thereto for control thereof, is installed at ceiling level, while a second subregional subset of beacons 104B, and an associated subregional beacon controller 102B connected thereto for control thereof, is installed at much lower elevation on or adjacent a workstation 200, for subregional tracking of a target device 106 within a localized workspace (e.g. atop a benchtop work surface) that denotes a smaller subregion of the larger region being monitored by the first regional subset of beacons 104A installed overhead at ceiling level.

It will be appreciated that, in the present embodiment, where each beacon controller 102 is a separate component from each beacon 104, and relies on cabled connection between the controller 102 and its respective set of beacons 104, the regional beacon controller 102A responsible for control of the elevated ceiling-level regional subset of beacons 104A need not necessarily be mounted at ceiling level itself, and could reside at a more accessible location nearer to the ground level for more convenient access. Also, while the illustrated example shows all of the elevated regional subset of beacons 104A being connected to a different beacon controller 102A than any of the workstation's subregional subset of beacons 104B, any beacon controller 102A, 102B could optionally host a mixture of beacons from the different regional and subregional subsets 104A, 104B.

To have concurrent operation of the regional beacons 104A and subregional beacons 104B, separate frequency windows may be employed for their respective acoustic positioning signals, for example with the regional beacons 104A emitting acoustic positioning signals in a 20-40 KHz frequency range, and the subregional beacons emitting acoustic positioning signals in a 40-60 KHz frequency range. The regional beacons 104A preferably use the lower of the two frequency ranges, since signal attenuation loss is reduced at lower frequencies and would allow the signal to travel further and cover a wider regional service area. The higher frequency range is preferably used by the subregional beacons 104B where the shorter travel distance is desirable, as there may be several workstations 200 situated in close proximity to one other which that use the same frequency range, though it will also be appreciated that the volume of the acoustic positioning signals may also be adjusted in both cases to better respective the usable service ranges among the various beacon groups, depending on relative size and proximity of regions and subregions. Acoustic positioning signals from among the regional and subregional beacons 104A, 104B may be used concurrently or separately in calculation of target device position.

Turning back to FIG. 5, this time from the perspective of the target device 106 whose executional steps are numbered as 14NN in the right half of the diagram, initial step 1400 of the target processor's share of the cooperatively executed routine may involve confirmation of the configured ready state of the beacon controllers 102, for example via receipt of a ready signal transmitted by RF communication from the beacon controllers 102 to the target device 106. At aforementioned step 1401, the ephemeris data transmitted from the beacon controller 102 is stored in the target memory 142. In alternative to being wirelessly transmitted from the beacon controller 102, the ephemeris data may be stored as a file and uploaded onto target device, or received as commands issued to the target device from an external application. All or some of this ephemeris data may be subjected to validation at step 1402. Concurrently, at step 1403, at a middle one of the three parallel branches of the illustrated target device logic flow of FIG. 5, the target device 106 starts monitoring for periodic receipt of the wireless synchronization signals 135 at its RF transceiver 144, and in response to receipt of each any such periodic wireless synchronization signal 135 at step 1404, the target processor 140, at step 1405, synchronizes the local clock of the target device 106 to those of the beacon controllers 102 and the system server 118. Concurrently, the target processor 140 sets a clock status flag to “usable” at step 1408, denoting that the synchronized clock of the target device 106 is usable for the purpose of calculating TOAs of the received acoustic positioning signals.

It is not necessary to continually receive a wireless synchronization signal at the target device 106, despite the fact that the reliability of the target device's clock accuracy will decrease over time due to clock drift, as schematically illustrated in FIG. 7. To protect against notable drift error, a clock accuracy threshold is applied, denoting a maximum length of time permitted to pass from the receipt of a wireless synchronization signal 135 before the target's device's clock is considered unreliable due to potentially excessive drift. The particularly selected accuracy threshold may vary depending on the accuracy rating of the target device's clock (typically expressed in parts per million, or ppm). In the graphed example, the accuracy threshold is shown to be at least as long as the transmission interval between sequential transmission of two wireless synchronization signals 135. This way, so long as two sequentially transmitted wireless synchronization signals 135 are both received by the target device 106, the clock thereof is considered reliable throughout the full timespan between those two received wireless synchronization signals 135.

Turning back to the left-hand one of the three parallel branches of the illustrated target device logic flow of FIG. 5, with valid ephemeris data now stored in the target memory 142, the target processor 140 starts to continuously sample audio from each acoustic receiver 154, 154A, via the respective ADC 156, 156A, into a respective buffer at step 1406 for the purpose of collecting digital audio that can be analyzed for detected receipt of the acoustic positioning signals 108. Storage of buffered audio samples is triggered after each instance of a received synchronization signal at 1404, and also after respective lapse of each of a plurality of sampling windows of predetermined length (e.g. predetermined number of samples) occurring between any successive two synchronization signals, which predetermined length can be defined within the received and stored ephemeris data and denotes a respective acoustic epoch long enough to capture acoustic positioning signal therein, whose expiration is denoted by step 1404A, the buffered sampling window from that acoustic sampling window, and optionally a timestamp thereof, are stored together in the target memory 142 at step 1410. Such sample buffering and periodic storage of buffered sample windows is repeated on an ongoing basis, to capture the repeating continuous loop of simultaneous unique acoustic positioning signals from the beacons of the one or more beacon controllers 102. The timestamp is not essential to identify TOA and calculate ranges, which can be derived from the known sample rate, the understanding that the synchronized acoustic positioning signals are emitted at time to and the speed of sound (optionally temperature adjusted for improved accuracy), but the timestamp of when the sample was recorded may still be useful, for example for time-based logging of tracked positions.

With this in mind, it will be understood that TOA need not necessarily be measured as an absolute time, nor need it necessarily be evaluated in time units, for example instead being evaluated in units of audio samples, in which same units the time offset between that TOA and the transmission time at which the audio positioning signal was transmitted by its respective beacon (denoting the time of flight (TOF) of the audio positioning signal) may also be evaluated. This time offset or TOF can subsequently converted into time units using the known audio sampling rate of the target device, so that the ultimately derived value in time units can be used to calculate the ranges between the target device and the beacons based on the known speed of sound (optionally compensated for local temperature, in embodiments equipped for such temperature compensation).

That said, in alternative to storage of a buffered sample window of predetermined sample size from with every received synchronization signal and epoch, discretely recorded and timestamped instances of audio could instead be captured on a repeating basis, starting at step 1406, each time storing the starting time of such audio sampling instance in the target memory 142, for example recording the starting time of the first such instance as that at which a wireless synchronization signal 135 is received. After a period of sampling time (sampling window) corresponding to the signal length of the unique acoustic positioning signals, as defined within the received and stored ephemeris data, the particular acoustic signal sampling instance would be stopped, and the audio sample and its starting time stored together in the target memory 142 at step 1407. Such sampling would be repeated on a continuous basis, with the timing thereof re-synchronized with each receipt of a synchronization signal, to capture the repeating continuous loop of simultaneous unique acoustic positioning signals from the beacons of the one or more beacon controllers 102.

In a preferred implementation, the clock accuracy threshold may simply be a threshold countdown timer that is reset and executed anew by the target processor 140 each time a wireless synchronization signal 135 is received. As long as the threshold countdown timer doesn't elapse, the clock of the target device 106 is considered acceptably accurate, and retains its “usable” status set at step 1408 by the last received synchronization signal 135. On the other hand, should the threshold countdown timer ever lapse before the next wireless synchronization signal 135 is received, then the clock of the target device is known to have crossed-over its accuracy threshold into unacceptable territory at step 1407, and is instead flagged as unusable at step 1409. This signifies that the clock of the target device 106 cannot be used for TOA calculation purposes, as the potential TOA inaccuracies introducible by the clock drift error are presumably too large to produce accurate positioning data from such calculated TOAs.

While the threshold countdown timer may be preferred for its simplicity, alternative means of implementing the clock accuracy threshold could instead be employed. For example, the thresholder crossover determination could instead be implemented as an event counter that counts how many periodic events of known repeating interval have passed since the last wireless synchronization signal 135 was received, for example by counting the number of audio sampling windows that have lapsed since receipt of that last wireless synchronization signal. In the example of FIG. 7, where each beacon 104 emits three of its unique positioning signals 108 for each wireless synch signal 135, each tracking device 106 accordingly captures three audio samples expected to contain those three transmitted acoustic positioning signals. If the target processor 140 counts completion of more than three audio sample windows since its last successful synchronization (at time t₀), this denotes crossover of the potential clock drift error past the threshold, and the clock of the target device is flagged as unreliable at step 1409. Time t₁ denotes lapse of the first acoustic sampling window and start of the second acoustic sampling window, and time t₂ denotes lapse of the second acoustic sampling window and start of the third acoustic sampling window, at the end of which the next wireless synchronization signal 135 would be expected, and would trigger resynchronization of the clock, reset of the event counter and flagging of the target device clock as usable. However, should the fourth sampling window at the terminal right end of the FIG. 7 timeline lapse without detected receipt of another synchronization signal 135 since the first t₀ of the timeline, then the threshold event counter would be exceeded, and the clock would be flagged as unusable.

So, referring back to FIG. 5, and regardless of the chosen method of threshold crossover detection, every time the clock of the target device 106 is synchronized at step 1405 by receipt of a wireless synchronization signal 135 at step 1404, and at any time the clock of the target device does not crossover the accuracy threshold into unacceptable territory at step 1407, the clock status flag of the target device is set or maintained as usable (i.e. reliable) at step 1408 for the purpose of calculating TOAs of the received acoustic positioning signals sampled at 1406. On the other hand, any time between two successively received wireless synchronization signals 135, if the clock of the target device is determined to have crossed-over its accuracy threshold into unacceptable territory at step 1407, then the clock status flag is instead set to unusable at step 1409, signifying that the clock of the target device cannot be used for such TOA calculation purposes, as the potential TOA inaccuracies introducible by the clock drift error are presumably too large to produce accurate positioning data from such calculated TOAs.

At step 1411, the stored audio samples are processed by the target processor 140 to locate recorded instances of the received acoustic positioning signals within each audio sample using known correlation offset methodology, where replica codes, matching those of the beacon-specific unique acoustic positioning signals, and stored locally on the target device, are compared to the audio sample to determine the time offset between the transmission and reception of those unique acoustic positioning signals, so that respective TOAs of the recorded acoustic positioning signals can be determined to calculate the range of the target device 106 from each of the beacons 104 from which each of those recorded acoustic positioning signals was emitted. From this, the position of the target device 106 can be derived (presuming receipt of such acoustic positioning signals from a sufficient quantity of beacons 104). Such calculation of the TOAs of the recorded acoustic positioning signals is performed differently depending on whether the target device clock is flagged as usable or unusable, as assessed at step 1412 of FIG. 5. If the target device clock is positively flagged as usable, then at step 1413 the TOAs of the recorded acoustic positioning signals positively identified in the stored audio sample are assigned TOAs whose values are derived from the local clock time at which those recorded acoustic positioning signals were found in the audio sample, given the flagged “usable” status of the target device's local clock. Presuming a sufficient quantity of recorded acoustic positioning signals were found, the determined TOAs thereof can accordingly be used to calculate the position of the target device using known multilateration techniques.

On the other hand, if the local clock of the target device was flagged as “unusuable” at step 1409, then at alternate step 1414, the TOAs of the recorded acoustic positioning signals positively identified in the stored audio sample cannot be accurately derived from the local clock of the target device 106 given the negatively flagged status thereof. The TOA and position calculation step 1414 in the event of the unusable status of the local clock must instead employ an alternative clockless derivation or estimation of TOAs and position, for example by solving for not just X, Y, Z coordinate points of the target's device's position using at least four unique acoustic positioning signals from four beacons, but additionally solving for a time difference (delta t) using a total of at least five unique acoustic positioning signals recorded and identified in the audio sample. Such techniques for resolving the position coordinates in absence of a synced local clock, but in presence of sufficient beacon signals, are known in the art, and therefore not described in further depth herein. Further detail on at least one example of such possible position derivation in the absence of clock synchronization can be found in Applicant's aforementioned US patent application.

It will be appreciated that this reference to need of at least four or five unique acoustic positioning signals from four beacons refers to fully three-dimensional implementations of the system, capable of tracking three-dimensional movement in a three-dimensional coordinate system, but there may also be useful implementations of the system used for two-dimensional tracking purposes in a two-dimensional X, Y reference frame with no Z-axis, for example a ground-vehicle navigating a two-dimensional ground or floor space, with no elevational tracking needs on a vertical Z-axis, since the tracked ground-vehicle has a fixed Z coordinate (Z=0). In such instance, pitch and roll are likewise fixed, and so the system only need solve for X and Y coordinates and yaw orientation (around the vertical Z-axis), in which case the number of necessary acoustic positioning signals to derive a solution is reduced to two or three.

In either event, once the target device's position has been calculated at step 1413 or 1414, it is stored in memory. Typically, the position calculation at steps 1413 or 1414 is performed locally on the target device 106, as shown, and the calculated position optionally stored locally in the target memory 142 and/or displayed in real time on a visual display of the target device 106 if so equipped, though the target device 106 will typically also forward the calculated position of the target device 106, and a timestamp of that calculated position, onward to the system server 118 via RF communication, for storage in the server memory 122 for historical data purposes, real time display on a visual display of the system server 118, or of a remote device communicable therewith over a network, for visibility of the target device's location to for monitoring personnel, or for any other practical use derivable by communication of the position data to, and storage of the position data at, the system server 118. Alternatively or additionally, the calculated position from the target device 106 may be transmitted to a robot, tool or other piece of equipment with a direct wired or wireless connection to the target device 106, i.e. without using the server as an intermediary to access such positioning information.

In an alternative implementation of the FIG. 5 routine, the clock steering steps differentiating between usable and unusable states of the target device clock and using a flagged state thereof to determine downstream calculation steps may optionally be omitted, for example omitting steps 1407-1409, 1412 and 1414, in which case each instance of step 1405 or 1404A is followed directly by step 1410. Accordingly, it should also be appreciated that while the illustrated example with clock steering transmits the wireless synchronization signals 135 at lesser frequency than the acoustic positioning signals 108 (as illustrated in FIG. 7), the beacon controller can alternatively transmit a wireless synchronization every time an acoustic positioning signal is transmitted, in a synchronized 1:1 fashion, as the clock steering serves as useful reliability feature for epochs where the sync signal is not received due to interference, obstruction, etc. It will also be appreciated that in instances involving use of only a singular beacon controller 102, synchronization of the beacon controller clock is not mandatory, and steps 1303-1304 may therefore be omitted.

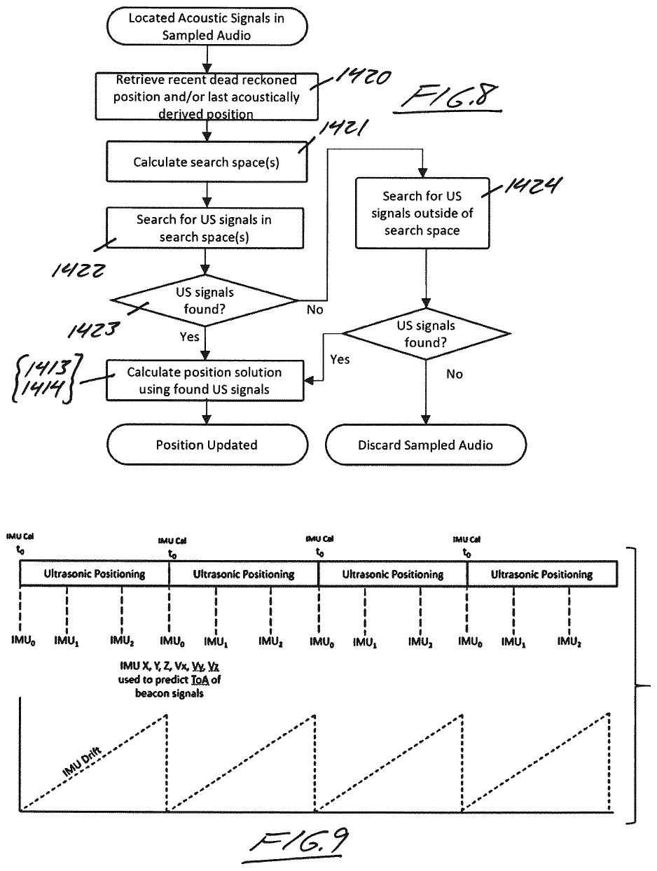

As mentioned earlier, preferred embodiments of the target device 106 include an IMU 160, and so the FIG. 5 flowchart, in the right hand one of the three parallel branches splitting off from initial step 1400, there is included periodic receipt of IMU output data from the IMU 160 to the target processor 140 at step 1415, which IMU data can be communicated to the target processor 140 at higher frequency intervals than that at which the acoustic positioning signals 108 are transmitted from the beacons 104, as schematically illustrated in FIG. 9. The IMU data is therefore usable by the target processor 140 to calculate dead reckoned positions of the target device 106 at intervals between acoustically based derivations of the target device position from steps 1413 and 1414. Calculation of such dead reckoned position of the target device each time an IMU data set is received from the IMU 160 is shown in FIG. 5 at step 1416. As described in more detail below in relation to FIG. 8, the latest dead reckoned position calculated at step 1416 can also be used as valuable input to step 1411 for efficient and effective signal searching for the recorded acoustic positioning signals in the sampled audio from step 1406. Useful data derived by or from the IMU, in the form of the raw IMU output in the illustrated FIG. 5 example, but alternatively in the form of the dead reckoned position calculated at 1416, can also be used as input to the TOA and position calculation steps 1413, 1414 to enable exploitation of sensor fusion therein to increase reliability, calculate attitude and/or lower computational power from a digital signal processing (DSP) perspective.

Those skilled in the art will recognize and understand from other multilateration systems, like the Global Positioning System (GPS), how the IMU 160 can used to “dead reckon” position output over time at step 1416 of FIG. 5. A visual representation of such dead reckoning of the target device is illustrated in FIG. 9, whose timeline is from the target device perspective. Each instance of IMU_{N} denotes receipt of a respective IMU data set from the IMU 160, and time to represents the end of one acoustic epoch at which an acoustic sample has been collected and processed at step 1413, 1414 to derive a target device position from the acoustic signal data, and at which another acoustic sample is begun. IMU₁ and IMU₂ thus denote IMU data sets measured amid an acoustic epoch, and thus usable by the target processor 140 to calculate dead reckoned positions at times between two acoustically derived positions calculated at the ends of two sequential acoustic epochs. In practice, there may be instances of t₀ where an insufficient quantity of acoustic positioning signals are received, recorded and identified in the given acoustic epoch to derive the target device position based solely thereon, but despite this deficiency, incorporation of calculated ranges for the beacons whose acoustic positioning signals were successfully received, recorded and identified can nonetheless be inputted to a Kalmann filter together with the IMU data to derive an IMU-augmented solution denoting a best guess estimation of the target device's position at the end of that acoustic epoch. For example, if only one, two, or three ranges are achievable from the processed acoustic positioning signals 108, this is not enough for a purely acoustic solution, but can be inputted into the TOA and position algorithm with the additional IMU data to narrow down where the target device may be, as use this a best guess position approximate with which to update the tracked position of the target device 106.

FIG. 5 schematically illustrates, via broken line process arrows, incorporation of IMU data into the TOA and position calculation steps 1413, 1414 to enable such IMU-augmented calculation of acoustically-derived position results garnered at least partly on the basis of the acoustic positioning signals 108. Given the sensor fusion context of this implementation, it will be appreciated that any reference herein to acoustically-based or acoustically-derived position determination refers simply to a position determination based at least partly on, and not necessarily exclusively on, acoustic positioning signals 108. Like the clock of the target device, the IMU 160 will likewise drift over time, as schematically illustrated in FIG. 9 with an IMU drift error plot similar to the clock drift error plot of FIG. 7. To address this, the IMU 160 is “steered” by using the acoustically based position result from steps 1413, 1414 at the end of each acoustic epoch to calibrate (drift-correct) the IMU at step 1417 of FIG. 5. In FIG. 9, such periodic recalibration of the IMU achieves the illustrated drop-off of the IMU drift error at the end of each acoustic epoch. In the illustrated example, IMU data set IMU₀ is measured at t₀, and in the event of zero usable acoustic positioning signals at such time, may be used as another dead reckoned position building off those preceding it, given that no acoustically based position is possible in such instance. As time increases since the last acoustically based position result, the accuracy of the position information derivable from the IMU data decreases, and grows in its “estimated” character. As a non-limiting example, the IMU measurement rate may be around 50 Hz, with dead reckoned positions thus outputted at a matching rate, so long as the IMU drift error threshold is not exceeded before recalibration of the IMU using a next acoustically-derived position. Meanwhile, the ultrasonic positioning rate, or ranging frequency, may be varied according to overall accuracy requirements of a given application or scenario.

While the above described implementation illustrated in FIG. 5 is a sensor fusion approach making use of both the IMU and the acoustic positioning signals, it will be appreciated that the uniquely beneficial ability of the dual-microphone target device 106′ to derive orientation information is not dependent on the inclusion of an IMU in all embodiments, as the inclusion of the two microphones on the target device 106′ at a known fixed distance to one another (which distance is stored in the target memory for use in the calculated derivation of orientation) is sufficient on its own to calculate orientation, though inclusion of the IMU for a sensor fusion solution to position and orientation is preferred for greater reliability.

The degree to which the ultrasonic orientation data and the IMU data are coupled in the chosen sensor fusion solution may also be varied. The solution can be loosely coupled in implementations where the IMU sensor fusion routine of FIG. 5 is configured to omit the feeding of raw IMU data to steps 1413, 1414 from step 1415 (as shown in broken lines) and instead uses the IMU for dead reckoning only, and thus uses a purely acoustic solution to derive the position and orientation of the target device, which are then used to perform calibration (drift-corrective state update) of the IMU to preserve/restore a reliability of the dead-reckoned position data derived from the IMU output. The solution is more tightly coupled when the broken line data flow paths are included to feed the raw IMU data to steps 1413, 1414 from step 1415, leading to a combined acoustic and inertial solution for the position and orientation of the target device, which in turn is then used to perform calibration (drift-corrective state update) for a superior result of greater accuracy. In either case, the sensor fusion routine can singularly derive a singular 3D position and 3D orientation from the Kalmann filter whose input includes the known distance between the two microphones, or can instead use the Kalmann filter to first solve for two discrete 3D positions for the two microphones, and then, using the known distance therebetween, then separately calculate the 3D orientation.

Some sensor fusion embodiments may use the dual-microphone setup only to update the yaw aspect of the target device orientation, and instead rely on the IMU data for the pitch and roll aspects, given the IMU's inability to derive yaw on its own. In preferred orientation-capable embodiments using the dual-microphone setup, audio sampling from both microphones may be performed for every acoustic epoch for greatest orientation accuracy. However, gyroscopic drift of the IMU is less severe than accelerometer drift thereof, and so other embodiments may instead sample a first primary one of the two microphones at each and every acoustic epoch for position determination and IMU accelerometer drift-correction purposes with each and every acoustic epoch, and sample a second supplemental one of the two microphones less frequently at a only a subset of the acoustic epochs, from which the two samples are thereby useful input to orientation determination and IMU gyroscopic drift-correction at intervals of lesser frequency.

FIG. 6 elaborates on an optional implementation of the beacon controller clock synchronization procedure from steps 1303 and 1304 of FIG. 5, which may employ the same logic executed by the target device 106 at steps 1404, 1405, and 1407-1409 in relation to the wireless synchronization signals 135 from the beacon controller 102, but executed in relation to the wired synchronization signals received from the system server 118 through the LAN connections 126, 136. In such implementations, the beacon controller 102 likewise monitors for crossover of an acceptable accuracy threshold set that is set according to the specified clock accuracy of the beacon controller's respective clock. Such beacon controller synchronization can thus be performed in like fashion to the timeline shown in FIG. 7 for the equivalent clock synchronization procedure of the target device 106, again whether using a simple threshold countdown timer or an event counter, for example counting the number of acoustic positioning signals transmitted since receipt of the last synchronization signal from the master clock of the system server 118. While FIG. 7 denotes an embodiment where synchronization signals are sent at lesser interval frequency than the acoustic positioning signals, this need not necessarily be the case, and for example, each transmission of the acoustic positioning signals 108 may instead coincide with transmission of a respective synchronization signal.

FIG. 8 details a preferred implementation for the acoustic positioning signal processing of the collected audio samples at step 1411 of FIG. 5, which takes particular advantage of the inclusion of the IMU 160 in each target device 106 to improve calculation efficiency in the processing of those acoustic positioning signals. Each time IMU data is received by the target processor 140 from the IMU 160 at step 1415 of FIG. 5, a dead reckoned position and velocity of the target device 106 is calculated using a Kalmann filter at step 1416, which position and velocity can be accompanied by a respective estimated quality of that measured position and velocity, all of which can be stored in the target memory 142 as a dead reckoned data set. This dead reckoned data set is usable as a predicted estimation of the target device's position that is to be acoustically derived for the given acoustic epoch using the acoustic positioning receiving signals received therein. The selected dead reckoned data set may be, for example, that derived from the most recent IMU reading prior to the expiration of the given sampling window (IMU₂ in the FIG. 9 example). This selected dead reckoned data set is used by the target processor 140 at step 1421 of FIG. 8 to calculate at least one search space, in the time and/or frequency domain, in which to look for the acoustic positioning signals 108 within the sampled audio of the given acoustic epoch at step 1422. Preferably, both a doppler search space and a spatial search space are calculated, and both may be configured to operate to a specified confidence.

The dead reckoned position/velocity/orientation derived from the IMU serves as a predicted position/velocity/orientation ahead of the acoustic processing steps, enabling predictive target device tracking where the predicted position derived from the IMU is used to calculate estimations of what the ranges from the tracking device to each beacon, which estimated ranges are then used to aid the time and frequency domain searches for the acoustic positioning signals. For time-based searches using the known correlation offset methodology referenced above, the search window in which to look for correlation peaks of each uniquely identifiable acoustic positioning signal is constrained using the estimated ranges to the respective beacons from which those uniquely identifiable positioning signals originate.

The search window can be dynamically adjusted by the target device processor based on detected conditions (motion, noise, etc.), which can be beneficially leveraged to reject false peaks from multipath, speaker anomalies or other errors, and thus enable detection and selection of relatively weak correlation peaks in more adverse conditions. For example, if the predicted velocity/acceleration is indicative of relatively pronounced motion/dynamics, the search window size may be expanded to account for greater variability in the potential whereabouts of the acoustic positioning signal. On the contrary, if the predicted velocity/acceleration is zero or negligible, then the search window size may be narrowed. As discussed further below, the microphone(s) of each target device can be leveraged to monitor signal to noise ratio (SNR) to make dynamic system adjustments to mitigate environmental noise, in which case the monitored SNR from a preceding acoustic epoch can be evaluated against some threshold, and in the event of a low SNR below that threshold, the search window size may be adjusted to compensate for presumably noisy conditions predicted for the current epoch under being analyzed.

The doppler search space defines a frequency window that must be searched for doppler shifted acoustic positioning signals 108. As the doppler effect varies depending on geometry, the dead reckoned position combined with the dead reckoned velocity is used to estimate the most likely doppler shift for each acoustic positioning signal 108. The component level standard deviation for both dead reckoned position and velocity combined with specified confidence may be used to calculate the frequency window size to search for the most likely doppler shift. It should be appreciated that doppler searches require Fourier transforms which are computationally expensive. Using the IMU dead reckoned position to define a targeted doppler search space greatly increase the computational efficiency of the doppler search. The formulation of the spatial search space may involve calculation of an estimated 3D shape that defines a predicted possible target device location to a preconfigured confidence. For instance, the preconfigured confidence may be set to 99.7% (or three sigma), which would use the component level 3D standard deviations (in coordinate directions X, Y and Z) to calculate a spheroid by multiplying each X, Y, Z component by three, in centered relation to the dead reckoned position, to form the spatial search space. From the calculated spatial search space, the target processor 140 can calculate which of the various beacons'acoustic positioning signals 108 should have been receivable by the target device 106 in the given acoustic epoch, and thereby compile a specific list of unique acoustic positioning signals to search for. It will be appreciated that multipath/echoes are a very big issue with acoustic measurements, and using the spatial search space may eliminate or reduce the possibility of falsely interpretating non-line-of-sight signals (echoes, reflections) as direct line-of-sight signals suitable for ranging. In alternative to derivation of the spatial search space from a recent or latest dead reckoned data set, the spatial search space may alternatively be calculated from the last acoustically derived position of the target device resulting from the processing of the prior acoustic epoch, whose optional retrieval is therefore also shown at step 1420 as alternative or supplemental input to the recent/latest dead reckoned data set.

If searching of the targeted search space(s) at step 1422 of FIG. 8 has successfully located unique acoustic positioning signals in the sampled audio at step 1423, then the calculation of TOAs and target device position can continue at either step 1413 or 1414 of FIG. 5, depending on the target device clock status. On the other hand, if unique acoustic positioning signals were not found within either targeted search space, then further processing of the audio sample outside the targeted search spaces can be conducted at step 1424 of FIG. 8, at increased computational expense. The formulation and targeted searching of IMU-derived search spaces also helps with environmental noise, for which other methods of compensation are also described herein further below.

In at least some preferred embodiments, the IMU 160 is also used to calculate the attitude/3D orientation of the target device (roll, pitch and yaw). Those skilled in the art will appreciate that an IMU 160 can output stable and accurate roll and pitch relative to the gravity vector, but that yaw cannot be derived from gravity, but may be derived using magnetic field as reference. However, in the indoor context of the present invention, due to naturally occurring magnetic fields being weak or altered in indoor environments, a calibration of the IMU is required for accuracy. It is well known in the art that IMUs may be calibrated by using motion routines combined with precise single point multilateration/GPS positioning. In the instance of a dual-microphone target device 106′ of the type described above in relation to FIG. 4, the audio sampling at step 1406 of FIG. 5 includes collection of respective audio samples from both acoustic receivers 154, 154A via their respective ADCs 156, 156A, and the audio processing at step 1411 includes processing of both of the two audio samples from the two acoustic receivers, whereby the position calculation at step 1413 or 1414, depending on usable/unusable clock status, can be used to calculate two respective position points, one denoting the resolved position of acoustic receiver 154, and the other corresponding to the resolved position of acoustic receiver 154A, which two position points are thus solvable together with full orientation details (roll, pitch and yaw). In embodiments employing the dual-microphone target device 106′, IMU calibration/update step 1417 at the completion of each acoustic epoch can thus calibrate the IMU 160 for both position and full orientation about all three axes, in contrast to the single-microphone target device 106 of FIG. 3 which cannot resolve full orientation, lacking the ability to derive yaw, which can be valuable as indicator of a directional heading of the object being tracked. In alternate embodiments, the full orientation may be calculated using the position of both microphones as a follow-on step to such position calculation, rather than calculated together therewith in the Kalmann Filter.

Depending on the particular application of the system, there may or may not be a need for yaw/heading data, and so different embodiments may employ exclusively single-microphone target devices 106 (e.g. at lesser equipment cost) for applications lacking such need, exclusively dual-microphone target devices 106′ for position and full-orientation applications, or a mixture of single and dual microphone target devices 106, 106′ for mixed use applications where some target devices benefit from the inclusion of yaw/heading data that is unnecessary for others.

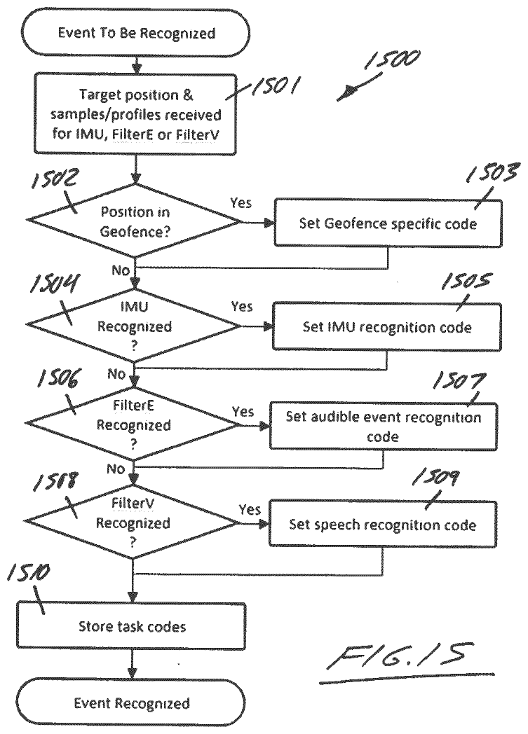

Alternatively, orientation calibration of the IMUs of single-microphone target devices 106 may be included, where instead of deriving two acoustically-derived position points from the acoustic epoch signal processing steps 1413, 1414 for automated periodic IMU orientation calibration at the regular epoch intervals, occasional IMU orientation calibration is achieved by user placement of a single-microphone target device 106 into the aforementioned target device holder 180 whose geometry is cooperatively configured relative to that of the target device 106 so as to enable receipt and holding of the target device by the target device holder 180 only when the target device 106 occupies a predetermined calibration orientation in the 3D reference frame of the positioning system 100. This is schematically illustrated in FIG. 14, where target device 106 is shown in solid lines in the predetermined orientation that allows it to be received and held by the cooperatively shaped target device holder 180, but is shown in broken lines in another orientation of non-matching relationship to the predetermined calibration orientation, in which mating engagement between the target holder 180 and the target device 106 is prohibited by the shape profiles thereof.

In a preferred implementation, the location of the device holder 180 within the indoor environment 110 monitored by the system 100 is stored in the target memory 142, for example having been received by the target device 106 as a component of the ephemeris data received at step 1401 of FIG. 5. This way, a precise acoustically derived position of the target device outputted from step 1413 or 1414 can be compared against the stored location of the target device holder to automatically determine whether the target device is currently held by the target device holder 180. Such confirmed presence of the target device 106 precisely at the known location of the target device holder 180, within the permitted tolerance, thereby confirms the target device's current orientation as being the predetermined calibration orientation imparted to the target device when held by the target device holder 108, given that the geometries of the two components only enable mated engagement thereof in that predetermined calibration orientation. Such detected matching of the target device and target device holder positions using the positional data outputted from step 1413 or 1414 thereby triggers position and orientation calibration (drift-corrective status update) of the IMU 160 at step 1417. This implementation exploits the inherent position-tracking capability of the system 100 to confirm the presence of the target device 106 in any installed target device holder 180 (e.g. jig or holster) whose location has been recorded in the target memory 142 of each target device 106, though as mentioned earlier, a presence detection sensor could alternatively be employed to confirm mated receipt of a target device 106 in a target device holder 180, and to trigger the IMU calibration.

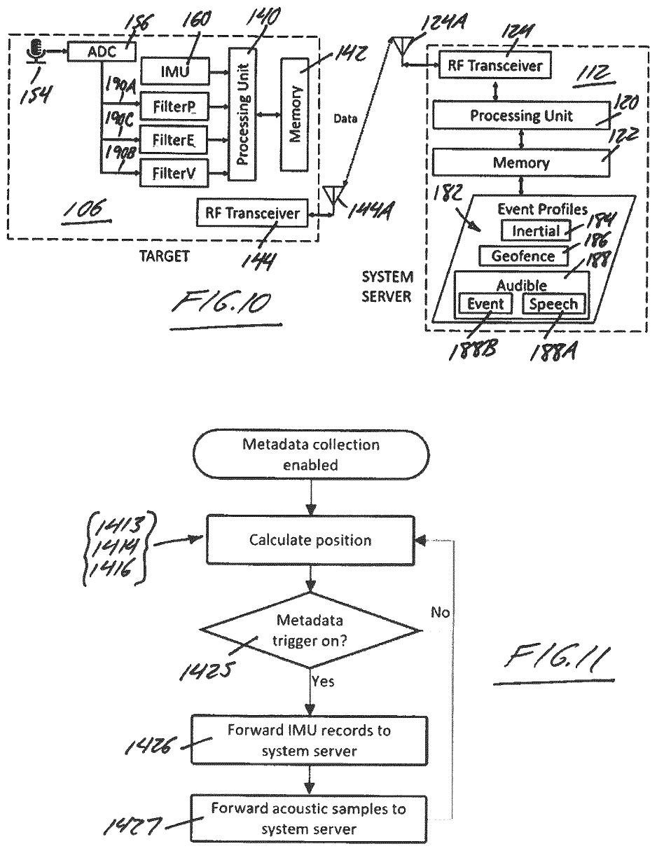

The description thus far has focussed on the position tracking functionality of the inventive system 100, but FIGS. 10 to 12 and 15 illustrate a further capability of the illustrated embodiment, by which the system 100 is also capable of detecting the occurrence of a variety of pre-characterized events in the monitored indoor environment 110, such as, but not limited to, performance of tasks by human or robotic workers within that indoor environment 110. Referring to FIG. 10, the server memory 122 has stored therein a plurality of event profiles 182, each of which contains data representative of one or more detectable characteristics of a pre-characterized event, which event characteristic data may include any one or more of: an inertial aspect 184 comparable against collected IMU data from the IMUs 160 of the target devices 106, a geofence aspect 186 for comparison against the tracked position of the target device 106, and one or more audible aspects 188 for comparison against recorded audio from the one or more acoustic receivers 154, 154A of the target device 106, 106′. Among such audible aspects 188, there may be further subcategorization, for example between speech aspects 188A for comparison against recorded speech of a human user of a target device 106, and non-speech aspects 188B for comparison against various recorded audio other than human speech, for example sounds emitted by particular tools during performance of working tasks therewith.

As one non-limiting example, a pre-characterized event characterized by a combination of such aspects could be the torquing of a torque wrench in a factory setting, by which worker performance of any one instance of that pre-characterized event can be characterized by tool vibration of a particular vibration frequency, denoting an inertial aspect confirmable from the IMU data from the IMU 160 of a target device 106 on the wrench; tool emitted sound characterized by a particular audible frequency denoting an audibly detectable non-speech aspect; spoken utterance of a particular keyword or phrase by a user of tool to signify intended performance of the task (e.g. “torque bolt number one”) denoting an audibly detectable speech aspect; and/or geofence coordinates denoting boundaries of a particular workspace in which the task is to be performed (e.g. where the wrench is expected to reside during the torquing of a particular bolt at a particular location on a workpiece of jig-supported or otherwise fixed or known location).

The target device 106 of FIG. 10 denotes a preferred implementation of the target device for particularly optimized event detection capability, where output from the acoustic receiver 154 and its ADC is split into three separate channels, which in the illustrated embodiment include a positioning channel 190A assigned to handling of the acoustic positioning signals, a voice channel 190B assigned to handling of audible human speech, and an event channel 190C assigned to handling of audible events other than human speech (audible non-speech events). The different channels 190A-190C may employ different respective hardware filters setup to exclude signals outside a particular frequency window optimized for the targeted purpose of that channel, for example with a positioning signal filter (FilterP) on the positioning channel 190A excluding signals outside the one or more frequency windows of the acoustic positioning signals (e.g. 20-40 kHz for regional beacons 104A & 40-60 kHz for subregional beacons 104B), a voice filter (FilterV) on the voice channel 190B excluding frequencies above 5 kHz, and an event filter (FilterE) on the event channel 190C configured according to whatever working tasks or other audible non-speech events that channel is dedicated to (e.g. to exclude frequencies outside a range 5-10 kHz chosen to capture audible torque wrench or other tool-performed tasks).

If a permanent noise source is found in the indoor environment that produces noise within the one or more frequency windows, the acoustic positioning signals 108 can be modified to not broadcast on the noise source's emitted noise frequency, and a hardware filter may be installed on the target device 106 to block out the problematic noise frequency. By using a dedicated and specifically filtered positioning channel 190A, this channel alone can be used for audio sampling step 1406 of FIG. 5 that feeds the positioning algorithms at steps 1413 and 1414, so that the samples ideally contain only the acoustic positioning signals 108 with minimal noise. That said, while the system 100 is in operation, transient noises sources may emit in the ultrasonic frequency windows of the acoustic positioning signals 108. In such case, the noise is typically attributable to point noise sources where the signal to noise ratio (SNR) of one or more beacon's acoustic positioning signals gets degraded as the noise source is approached by the moving target device 106. The target processor 140 may monitor SNR relative to the target device's tracked position, or forward captured audio or SNR data from such captured audio to the server 118 for further processing thereby, to determine the location of the noise source and attempt to characterize the noise source (e.g. in terms of broad vs. narrow frequency band) and adaptively remove it. For example, in the event of high SNR detection, the noise detecting processor may signal the beacon controllers (or a subset thereof near the detected location of the noise source) to temporarily pause transmission of the acoustic positioning signals 108, and trigger recordal of a clean audio sample of the noise in absence of the acoustic positioning signals. This clean audio sample can then be analyzed, to enable subtraction of the offending noise from subsequent audio samples when the regular signal transmission and audio sampling is restarted after this noise-targeting sample window. This presumes that the acoustic positioning signals are not saturated by the noise source, and the noise subtraction may accompanied by volume increase of the acoustic positioning signals. If the detected noise is characterized as relatively narrow band, the system may change the acoustic positioning signals of the effected beacons to a different frequency band, code and/or length that is more robust. If the noise source is instead categorized as wide band, the code may be increased in length (making it easier to track amongst noise), or increased in volume as mentioned above. The positioning channel 190A and noise-adaptive processing is configured to take the doppler search space into consideration, to make sure that doppler shifted acoustic positioning signals are not filtered out by the dynamically adapted filtering of unwanted noise.

The collection of IMU and audio data from the IMU 160 and the voice and event channels 190B, 190C can be categorized herein as metadata collection, which collection can optionally be selectively enabled or disabled by an operating entity of the system, and optionally, even when enabled, made further subject to selective triggering of such metadata collection in particular scenarios where it would be particularly useful to collect such data from which activity in the indoor environment, e.g. on the factory floor can be deduced, and monitored or logged. Per the above torque wrench example, the IMU 160 and the event channel 190C may be used to detect if a bolt is fastened by collecting vibration data from the IMU 160 and audio samples from the event channel 190C and comparing these against a pre-characterized event profile 182 to detect an occurrence of that pre-characterized event. A positively detected occurrence of any such pre-characterized event is then stored as a confirmed event data record, which preferably includes the current value of the tracked position of the target device 106 at the time that the detected instance of the pre-characterized event occurred, and a timestamp of that time.

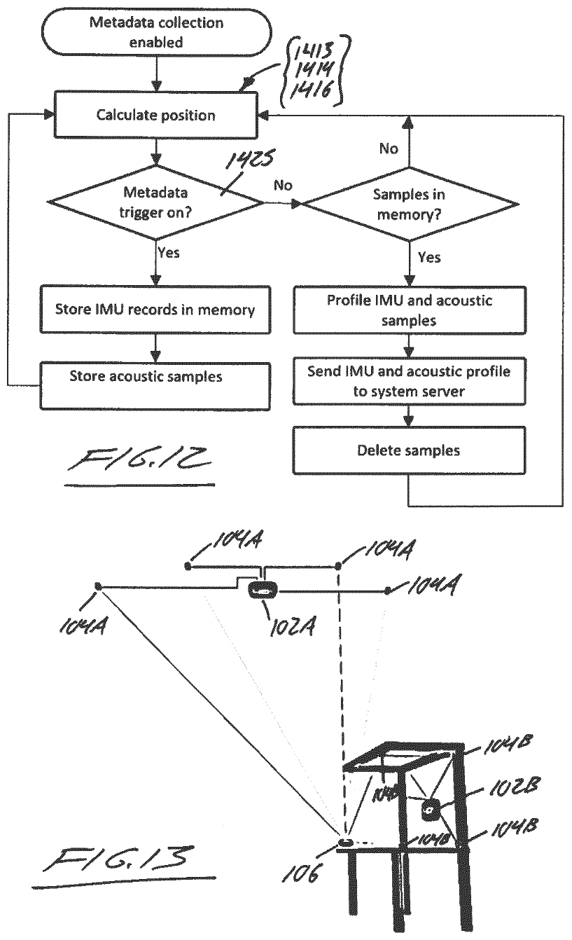

One implementation of this is illustrated in FIG. 11, where a target device's determination of its current position (dead reckoned position at step 1416 of FIG. 5, or acoustically based position derived from step 1413 or 1414) is followed by a check, by the target processor 140, at step 1425 of whether metadata collection has been triggered. If so, the latest collected IMU data and audio samples from the voice and event channels 190B, 190C are forwarded to the system server 118 at steps 1426 and 1427, in supplement to the normally transmitted target device position and timestamp thereof. With the added metadata, the system server 118 compares that IMU data and those voice and event channel audio samples against the stored pre-characterized event profiles 182 and determines whether an instance of any one of the pre-characterized events has occurred at the location and time denoted by the current target device position and its timestamp. This confirmed event instance can then be displayed in real-time to monitoring personnel, and/or logged in memory 122, for example depending on the type of event detected. For example, detected instances of working tasks associated with manufacturing operations on a factory floor can be used to build a thorough quality-control record of an article's fabrication and/or assembly, or to monitor or log worker performance. Meanwhile, having offloaded the event instance detection to the system server 118, the target device 106 can continue onward with repetition of its positioning related operations, as shown by return of step 1427 of FIG. 11 to positioning related steps 1413, 1414, 1416.

Activation of the metadata collection trigger may be initiated, for example by detection that the target device 106 has crossed a geofence boundary embodied in the geofence aspect 186 of an event profile 182, such determination for example being made by the system server 118 upon receipt of the latest determined position of the target device, in response to which the system server sends a metadata trigger activation signal to the target device via RF communication. Alternatively, the geofence aspects 186 of the event profiles 182 may be stored on the target devices 106, whether in alternative or redundancy to storage thereof on the system server 118, whereby the geofence penetration can be detected locally on the target device 106, optionally before transmission of the latest target device position to the system server 118, in which case the position data and metadata can be transmitted together to the system server 118. Alternatively, activation of the metadata collection trigger may be initiated by manual user input on the target device 106, or administrative input at the system server 118 that causes transmission of a trigger activation signal to the target device 106 via RF signal, which administrative input itself may be an inbound signal to the system server 118 from a third party server communicable therewith over a network. As yet another alternative, activation of the metadata collection trigger may be by voice command detected on the voice channel 190B, in which case the audible speech aspects 188A of the event profiles 182 may be stored on the target devices 106, whether in alternative or redundancy to storage thereof on the system server 118, whereby the trigger activating voice command can be detected locally on the target device 106.

While the FIG. 11 example shows a singular metadata trigger whose status determines whether both or neither of the audio and the IMU metadata content is sent to the system server 118, an alternative implementation may institute multiple trigger toggles by which transmission of IMU, voice channel audio and event channel audio can be individually toggled on and off. While the illustrated embodiment performs the event detection (metadata vs. event profile comparison) at the system server 118, it may be performed locally on the target device 106, or by another processing capable piece of equipment to which the collected metadata is communicable, whether directly from the target device, or via the system server 118. Likewise, it will be appreciated that various processing tasks described herein as being performed locally on the target device 106 may alternatively be executed by another processing capable piece of equipment communicable with the target device, whether directly or via the system server 118, if the amount of data transfer and communication speed involved to offload such processing tasks from the target device to the system server 118 or other equipment does not defeat the effectively “real time” determination of the target device position.

FIG. 12 illustrates an alternative implementation to that of FIG. 11. In the FIG. 12 example, when the metadata collection trigger found to be on at step 1425, following a position determination from step 1413, 1414 or 1416, the target device may iteratively store the IMU and acoustic samples in the target memory 142. When the metadata trigger is switched to off, the target device 106 may compute a frequency profile (Fourier transform) of the IMU and acoustic event samples, forward it to the system server 118 or other destination, then delete the samples. This implementation reduces the RF traffic relative to the FIG. 11 implementation. The system server 118 or other recipient would then use the FFT to profile and detect inertial and audible non-speech aspects of pre-characterized events.

FIG. 15 illustrates the event detection process 1500 executed by the system server 118, or other processing capable recipient of the event-relevant data (position data, IMU data, speech and event audio samples, or frequency profiles thereof) against the pre-characterized event profiles 182 stored in memory 122. It will be appreciated that multiple event profiles 182 may share one or more common characteristics among the different aspect categories, for example a common torque wrench task that may be characterized by the identical IMU vibration and same spoken keywords (“tighten bolt”) and tool sound, but be performed on different bolts residing in different geofenced locations in the workspace. Given this, the system server 118 may maintain a master list of aspect profiles, for example including geofence profiles, inertial profiles, voice/speech audio profiles, and non-speech audio profiles, and thus compare each event-relevant data set against the master list of aspect profiles, rather than against specific event profiles. Each aspect profile in the master list has a respective recognition code assigned thereto, and each event profile has stored therein a respectively unique set of recognition codes. The event detection process 1500, after receipt of the event-relevant data set at step 1501, thus compares the received position coordinates of the target device 106 against the master list of geofence profiles at step 1502 and if the target device position is found to be within the bounds of a profiled 2D or 3D geofence, the geofence recognition code of that matched geofence profile is assigned to the event-relevant data set at step 1503. Similarly, at step 1504, received IMU data (raw, or frequency profiled) is compared against the master list of inertial profiles, and if a match is found, the recognition code of that matched inertial profile is assigned to the event-relevant data set at step 1505. Similarly, at step 1506, the received audio sample (or frequency profile) from the event channel 190C is compared against the master list of non-speech audio profiles, and if a match is found, the recognition code of that matched non-speech audio profile is assigned to the event-relevant data set at step 1507. Similarly, at step 1508, the received audio sample from the voice channel 190B is compared against the master list of voice/speech audio profiles, and if a match is found, the recognition code of that matched voice/speech audio profile is assigned to the event-relevant data set at step 1509. The assigned recognition codes are compiled and stored in association with the event-relevant data set at step 1510, achieving a fully profiled event-relevant data set, which can then be compared against the full event profiles 182 to confirm whether a pre-characterized event has occurred. If the compiled codes don't match any of the full event profiles 182, the compiled codes may nonetheless be stored as a potential event occurrence, but flagged as an unrecognized event.

Completion of tool performed tasks associated with a tool emitted sound and detectible inertial aspect (e.g. vibration frequency) are merely one example of detectable pre-characterized events. Picking a part or product off a shelf in a warehouse space for example can be characterized by a detectable speech aspect (worker announcement of the picking task, e.g. “Picking Part X”), combined with a geofence boundary around a shelf area where the part or product is known to be stored, which pre-characterized event profile may lack any audible non-speech or inertial aspect. A “help request” event may be characterized solely by an audible speech aspect denoting spoken utterance of the word “help” by a worker carrying a target device 106, for which the metadata trigger may be depression of a voice command button on the target device 106. The geofence aspects may include two dimensional geofences, three dimensional geofences, or combinations thereof. Other input usable to validate instances of pre-characterized events may include data types other than those specifically contemplated above, for example including externally sourced data communicated to the target device from another device, for example a digital torque wrench that sends a torque reading to the target device, for matching against prescribed torque values stored as tool job profiles in the master list, or as tool aspects of the event profiles 182.

In addition to use for event detection purposes, audio samples from the voice channel may be processed with voice recognition technology at the system server 118 or other receiving equipment in order to digitize what was spoken, which digitized speech may then be used to command execution of any instructible aspect of the positioning system, passed on for similar command purpose to an external equipment or process, or stored as a means of logging verbally inputted information.

While the illustrated embodiments of FIGS. 1, 2 and 13 use a shared beacon tor spoke-and-hub topology where multiple beacons share a singular beacon controller among them, it will be appreciated that this particular topology is not essential to other novelties described and claimed herein, including the multi-microphone target devices with orientation-deriving capability, the event-detection methodology using captured acoustic and/or IMU data to detect and log occurrence of profiled events, regional and subregional tracking by differently configured groups of beacons, use of the tracker microphone for noise analysis and correction, and use of IMU dead-reckoning for targeted acoustic signal searching.

Alternative embodiments using a 1:1 controller-to-beacon topology may include embodiments where the beacon controller and its respective beacon are still housed separately and interconnected by wired connection, but also embodiments where the beacon controller and its respective beacon are integrated together into a singular unit. It will also be appreciated that serverless implementations of the system are also possible, where one of the beacon controllers replaces any one or more of the described components or functionalities of the server, and serves as a master beacon controller whose clock is the master to which the other beacon controllers are synchronized. While the illustrated embodiment employs LAN-based beacon controller clock synchronization over a wired LAN, other embodiments may alternatively employ wireless clock synchronization (like that used to synchronize the target devices to the beacon controllers) to synchronize the beacon controllers with one another (whether from a server, or a master beacon controller among said beacon controllers).

Since various modifications can be made in the invention as herein above described, and many apparently widely different embodiments of same made, it is intended that all matter contained in the accompanying specification shall be interpreted as illustrative only and not in a limiting sense.

1. A target device for use in a positioning system comprising a plurality of beacons of known location emitting respectively identifiable acoustic positioning signals within a space in which said target device is to be tracked, said target device comprising at least two acoustic receivers occupying different points on said target device, and a processor configured to analyze sampled audio from said at least two acoustic receivers to locate therein recorded instances of said respectively identifiable acoustic positioning signals and determine, for successfully located acoustic positioning signals found in said sampled audio, time offsets between transmission of said successfully located acoustic positioning signals by the beacons and reception of said successfully located acoustic positioning signals by the at least two acoustic receivers, for calculation of both an acoustically-derived position and acoustically derived orientation of the target device using at least said time offsets.

2. The device of claim 1 wherein said target device further comprises an inertial measurement unit (IMU).

3. The device of claim 2 wherein said target device is configured to correct IMU drift based, at least in part, on said acoustically derived orientation of the target device.

4. The device of claim 2 wherein said processor receives IMU data from the IMU more frequently than the acoustic positioning signals are transmitted by the beacons, and the processor calculates dead reckoned positions of the target device.

5. The device of claim 4 wherein said processor is configured to update a tracked position of the target device based on said dead reckoned positions.

6. The device of claim 4 wherein said processor is configured to, using at least (a) one of said dead reckoned positions, and/or (b) a preceding instance of an acoustically derived position of the target device, calculate at least one search space, in which to search sampled audio from at least one of the two acoustic receivers for the respectively identifiable acoustic positioning signals.

7. The device of claim 6 wherein said at least one search space comprises a doppler search space.

8. The device of claim 6 wherein said at least one search space comprises a spatial search space.

9. The device of claim 6 wherein said at least one search space comprises time-based search space constrained by estimate ranges from the tracking device to at least some of the beacons, which estimated ranges are derived from said one of said dead reckoned positions.

10. The device of claim 1 wherein said target device further comprises an RF receiver for receiving, at least, wireless synchronization signals from one or more beacon controllers that trigger synchronized transmission of the respectively identifiable positioning signals from said plurality of beacons.

11. The device of claim 10 wherein the target device comprises an audio data buffer continuously populated with audio samples from at least one of the acoustic receivers, and is configured to periodically record from the audio data buffer, in triggered response to at least some of the wireless synchronization signals, a respective sample window of predetermined sample size, which respective sample window is analyzed to find said recorded instances of the respectively identifiable acoustic positioning signals from said at least one of the acoustic receivers.

12. The device of claim 10 wherein the target device is configured to:
monitor a clock drift status of a local clock of said target device; and
depending on said clock drift status, select between different clock-based and clockless position calculation methods for processing sampled audio from said at least one acoustic transmitters.

13. The device of claim 12 wherein the target device is configured to, after receipt of the wireless synchronization signal, monitor whether a next wireless synchronization signal is received within a threshold period, and assign a usable or unusable clock status to the local clock of the target device depending whether the next wireless synchronization was received, or not received, within said threshold period.

14. The system of claim 13 wherein the target device runs a threshold countdown timer in response to the wireless synchronization signal to track passage of the threshold period.

15. The device of claim 1 wherein said target device is configured to process sampled audio from a first one of the two acoustic receivers more frequently than sampled audio from a second one of the acoustic receivers.

16. The device of claim 15 wherein each processed instance of sampled audio from the second one of the acoustic receivers is accompanied by a processed instance of simultaneously sampled audio from the first one of the acoustic receivers.

17. The device of claim 1 wherein the target device is further configured to calculate said acoustically derived orientation of the target device less frequently than said acoustically derived position of the target device.

18. The device of claim 1 wherein said processor of the target device is configured to search the sampled audio for wideband positioning signals from the beacons.

19. The device of claim 1 comprising non-transitory computer readable memory in which there is stored, for access and use by said processor, a known distance between said two acoustic receivers for use in said calculation of both said acoustically-derived position and said acoustically derived orientation of the target device.

20. The device of claim 1 wherein at least one of the acoustic receivers is configured for audio sampling of not only said respectively identifiable acoustic positioning signals, but also other audio.

21. An event and position tracking apparatus for use in a positioning system comprising a plurality of beacons emitting respectively identifiable acoustic positioning signals within a space, said apparatus comprising:
a target device whose position within said space is trackable by the system; and
non-transitory computer readable memory, embodied in said target device or another processor-equipped device communicable therewith, in which there is stored pre-characterized event profiles representative of predefined events detectable within said space using one or more samples or measurements taken by said target device;
wherein at least one local processor of said target device, or at least one other processor embodied in said another processor-equipped device communicable with said target device, is configured to:
compare said pre-characterized event profiles against said one or more samples or measurements taken by said target device to detect occurrences of said predefined events within said space; and
create and store a digital record of any detected occurrence of said predefined events, which digital record includes both a time and location at which said any detected occurrence occurred.

22. The apparatus of claim 21 wherein the target device comprises at least one acoustic receiver for receiving identifiable acoustic positioning signals from the system for use in determining said position of said target device within said space, and said samples or measurements comprise audio samples recorded from the at least one acoustic receiver, among which samples are recorded both said acoustic positioning signals and other audio, of which said other audio comprises at least one of (a) speech; and (b) audible events other than speech, and at least one of said pre-characterized event profiles comprises sound data representative of audible aspects of at least one of said predefined events, against which said other audio is compared.

23. The apparatus of claim 21 wherein said target device comprises an inertial measurement unit (IMU), said samples or measurements comprises inertial measurement data from said, and at least one of said pre-characterized event profiles comprises comparative inertial data representative of inertial aspects of at least one of said predefined events, against which said inertial measurement data is compared.

24. The apparatus of claim 21 wherein at least one of said pre-characterized event profiles includes geofence data representative of one or more boundaries of a particular subspace within said space, for comparison against derived positions of the target device to detect a predefined location-specific event performed within said particular subspace of the space.

25. A positioning system for enabling determination of a position of a target device within a space, said system comprising:
one or more beacon controllers, each of which has a respective RF transmitter and is configured to repeatedly transmit a wireless synchronization signal therefrom for receipt of said wireless synchronization signal by said target device for clock synchronization purposes; and
for each one of the one or more beacon controllers, a respective plurality of beacon devices, among which each one of said respective plurality of beacon devices:
comprises a respective acoustic transmitter or receiver;
is communicatively connected to said one of the one or more beacon controllers via wired connection; and
is configured to wirelessly and repeatedly transmit or record, from said respective acoustic transmitter or receiver, and in response to signalled command over said wired connection from said one of the one or more beacon controllers in timed relation to a clock thereof, identifiable acoustic positioning signals for use in determination of time offsets between transmission and receipt of the identifiable acoustic positioning signals for the purpose of deriving at least a position of the target device.

26. The system of claim 25 wherein the beacon controller is configured to repeatedly transmit the wireless synchronization signal at lesser frequency than transmission or recording of the acoustic positioning signals such that more than two transmissions or recordings of said acoustic positioning signals occur for any two sequential transmissions of the wireless synchronization signal.

27. A target device for use in a positioning system comprising a plurality of beacons that operate under control of one or more beacon controllers and synchronously emit respectively identifiable acoustic positioning signals within a space, said target device comprising:
at least one acoustic receiver for receiving at least said respectively identifiable acoustic positioning signals for use in determination of a position of said target device within said space;
an RF receiver for receiving, at least, wireless synchronization signals from said one or more beacon controllers that trigger synchronized transmission of the respectively identifiable positioning signals from said plurality of beacons;
at least one processor that is configured to analyze sampled audio from said at least one acoustic receiver to locate therein recorded instances of said respectively identifiable acoustic positioning signals and determine, for successfully located acoustic positioning signals found in said sampled audio, time offsets between transmission of said successfully located acoustic positioning signals by the beacons and reception of said successfully located acoustic positioning signals by the at least two acoustic receivers; and
at least one audio data buffer continuously populated with audio samples from the at least one acoustic receiver;
wherein the target device is configured to periodically record from the at least one audio data buffer, in triggered response to at least some of the wireless synchronization signals, a sample window of predetermined sample size, which respective sample window is analyzed for said recorded instances of the respectively identifiable acoustic positioning signals.
